(19) United States
(12) Patent Application Publication
(10) Pub. No.: US 2025/0037223 A1
(43) Pub. Date: Jan. 30, 2025

(54) COMPUTER-BASED TOOL FOR ENTERPRISE CONTRACT ASSESSMENT

(71) Applicant: Wells Fargo Bank, N.A., San Francisco, CA (US)

(72) Inventors: Reggie Lee Gimlin, Matthews, NC (US); Kelly K. Hall, Charlotte, NC (US); Robert K. Gegg, Fenton, MO (US); Elizabeth M. Collins, Weddington, NC (US); Anh-Thu T. Gates, Charlotte, NC (US); Steve P. Thomas, Charlotte, NC (US); Gregory S. Patrell, Matthews, NC (US)

(21) Appl. No.: 17/487,983

(22) Filed: Sep. 28, 2021

Related U.S. Application Data
(60) Provisional application No. 63/084,995, filed on Sep. 29, 2020.

(51) Int. Cl. G06Q 50/18; G06Q 10/06; G06Q 10/10

(52) U.S. Cl. CPC G06Q 50/188; G06Q 10/0635; G06Q 10/10

(57) ABSTRACT

A computer-based system is described that includes a plurality of end-user devices and a computing device executing a contract assessment tool in an enterprise network. An example method includes initiating, by an agent device and with the contract assessment tool, an assessment session for a contract being negotiated; presenting, by the contract assessment tool and to the agent device, one or more prompts for information related to the contract; receiving, by the contract assessment tool and from the agent device, input data representative of the information related to the contract; determining, by the contract assessment tool, whether negotiations for the contract are to be escalated to an enterprise legal group; generating, by the contract assessment tool, one or more reports associated with the contract; and outputting, by the computing device, the one or more reports to at least one of the end-user devices.

This application claims the benefit of U.S. Provisional Patent Application No. 63/084,995, filed 29 Sep. 2020, the entire contents of which is incorporated herein by reference.

### TECHNICAL FIELD

The disclosure relates to computer-based systems.

### BACKGROUND

Contract creation between a line-of-business (LOB) within an enterprise and a third party provider is typically managed by one or more human agents employed by the enterprise. The contract creation process may include a significant amount of back and forth communication and negotiation between the agents, on behalf of the LOB of the enterprise, and the third party provider. During the contract creation process, the agent may be required to assess the current terms of the contract to ensure compliance with enterprise preferred terms, determine whether the enterprise legal group is to negotiate and/or review the contract, and determine which approvals are required to complete the contract.

### SUMMARY

In general, this disclosure describes a computer-based system that includes one or more computing devices configured to execute a contract assessment tool. In response to an agent device in an enterprise network initiating an assessment session for a contract being negotiated with a third party provider, the contract assessment tool executing on a computing device of the enterprise network provides human agents using the agent device with access to contract negotiation information for the contract. The agents are responsible for contract creation with third party providers to provide a product or service requested by a line-of-business (LOB) within the enterprise. The agents responsible for contract creation may also be referred to herein as consultants or supply chain consultants. The contract assessment tool is configured to guide the agents through the contract creation process by prompting the agents to input data representative of information related to a particular contract, automatically determining whether negotiations for the particular contract are to be escalated to a legal group within the enterprise based on the input, and automatically generating reports and other output in standard formats based on the input.

In some examples, the contract assessment tool may comprise a software application executing on the one or more computing devices that generates data representative of a user interface (UI) for display on agent devices through which the agents may view and modify contract negotiation information for one or more contracts. As one specific example, the contract assessment tool may comprise a workbook in a spreadsheet application (e.g., Microsoft Excel) using both formulas and macroinstructions (macros) executing on the one or more computing devices.

In one example, this disclosure is directed to a method comprising initiating, by an agent device of a plurality of agent devices in an enterprise network and with a contract assessment tool executing on a computing device in the enterprise network, an assessment session for a contract being negotiated with a third party provider, wherein during the assessment session, the agent device has access to contract negotiation information for the contract; presenting, by the contract assessment tool and to the agent device during the assessment session for the contract, one or more prompts for information related to the contract; receiving, by the contract assessment tool and from the agent device in response to the one or more prompts, input data representative of the information related to the contract; determining, by the contract assessment tool and based on the information related to the contract, whether negotiations for the contract are to be escalated to an enterprise legal group; generating, by the contract assessment tool and based on the information related to the contract, one or more reports associated with the contract; and outputting, by the computing device, the one or more reports to at least one of legal group devices, line-of-business devices, or executive devices within the enterprise network.

In another example, this disclosure is directed to a system comprising a plurality of agent devices in an enterprise network, wherein an agent device of the plurality of agent devices is configured to initiate, with a contract assessment tool executing on a computing device in the enterprise network, an assessment session for a contract being negotiated with a third party provider, wherein during the assessment session the agent device has access to contract negotiation information for the contract; and the computing device communicatively coupled to the one or more agent devices within the enterprise network. The computing device comprises one or more processors executing the contract assessment tool and is configured to present, to the agent device during the assessment session for the contract, one or more prompts for information related to the contract; receive, from the agent device in response to the one or more prompts, input data representative of the information related to the contract; determine, based on the information related to the contract, whether negotiations for the contract are to be escalated to an enterprise legal group; generate, based on the information related to the contract, one or more reports associated with the contract; and output the one or more reports to at least one of legal group devices, line-of-business devices, or executive devices within the enterprise network.

In a further example, this disclosure is directed to a computer-readable storage medium comprising instructions that, when executed, cause one or more processors to initiate, by an agent device in an enterprise network and with a contract assessment tool executing on a computing device in the enterprise network, an assessment session for a contract being negotiated with a third party provider, wherein during the assessment session the agent device has access to contract negotiation information for the contract; present, by the contract assessment tool and to the agent device during the assessment session for the contract, one or more prompts for information related to the contract; receive, by the contract assessment tool and from the agent device in response to the one or more prompts, input data representative of the information related to the contract; determine, by the contract assessment tool and based on the information related to the contract, whether negotiations for the contract are to be escalated to an enterprise legal group; generate, by the contract assessment tool and based on the information related to the contract, one or more reports associated with the contract; and output, by the computing device, the one or more reports to at least one of legal group devices, line-of-business devices, or executive devices within the enterprise network.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system including one or more computing devices configured to execute a contract assessment tool, in accordance with the techniques of this disclosure.

FIG. 2 is a block diagram illustrating an example computing device executing the contract assessment tool from FIG. 1 in greater detail.

FIGS. 3A-3C illustrate an example engagement assessment user interface generated by the contract assessment tool for display on an agent device, in accordance with the techniques of this disclosure.

FIG. 4 illustrates an example governing documents user interface generated by the contract assessment tool for display on an agent device, in accordance with the techniques of this disclosure.

FIGS. 5A-5G illustrate examples of evaluation of contract section of the engagement assessment user interface from FIG. 3A, in accordance with the techniques of this disclosure.

FIGS. 6A-6C illustrate examples of contract gap questionnaire user interface generated by the contract assessment tool for display on an agent device, in accordance with the techniques of this disclosure.

FIG. 7 illustrates an example legal escalation notification as part of the engagement assessment user interface from FIG. 3B, in accordance with the techniques of this disclosure.

FIG. 8 illustrates an example legal intake form user interface generated by the contract assessment tool for display on an agent device, in accordance with the techniques of this disclosure.

FIGS. 9A-9B illustrate an example engagement summary user interface generated by the contract assessment tool for display on an agent device, in accordance with the techniques of this disclosure.

FIG. 10 illustrates an example executive briefing user interface generated by the contract assessment tool for display on an agent device, in accordance with the techniques of this disclosure.

FIG. 11 illustrates an example risk assessment information user interface generated by the contract assessment tool for display on an agent device, in accordance with the techniques of this disclosure.

FIG. 12 illustrates an example approval requirements information user interface generated by the contract assessment tool for display on an agent device, in accordance with the techniques of this disclosure.

FIG. 13 is a flow diagram illustrating an example operation of a network system including an agent device and a computing device executing the contract assessment tool, in accordance with one or more techniques of this disclosure.

### DETAILED DESCRIPTION

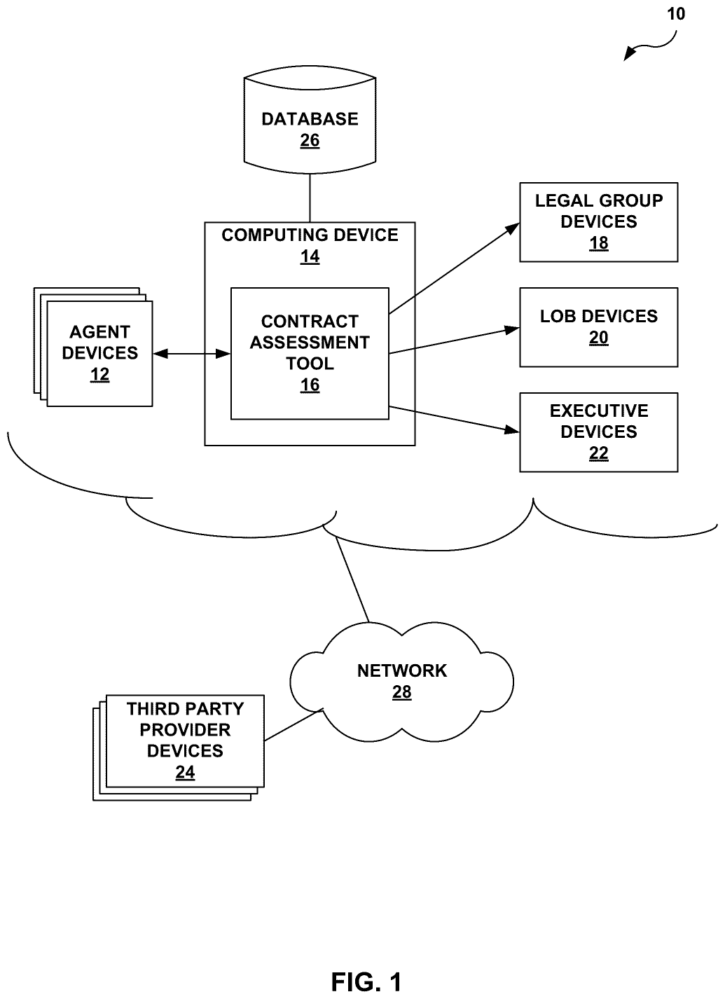

FIG. 1 is a block diagram illustrating an example network system 10 including one or more computing devices 14 configured to execute a contract assessment tool 16, in accordance with the techniques of this disclosure. In some examples, network system 10 may be associated with an enterprise, such as a financial institution or other company. As illustrated in FIG. 1, network system 10 includes computing device 14 executing contract assessment tool 16 that is accessible by agent devices 12 and that provides output to legal group devices 18, line-of-business (LOB) devices 20, and executive devices 22. In addition, one or more of agent devices 12 may be in communication with one or more third party provider devices 24 via a network 28 or a non-network based means of communication. As indicated in FIG. 1, third party provider devices 24 may be external to network system 10.

Network system 10 may comprise a private network including, for example, a private network associated with the enterprise. Network 28 may comprise a private network or may comprise a public network, such as the Internet. Although each are illustrated as a single entity, network system 10 and network 28 may each comprise a combination of public and/or private networks. In some examples, each of network system 10 and network 28 may comprise one or more of a wide area network (WAN) (e.g., the Internet), a local area network (LAN), a virtual private network (VPN), or another wired or wireless communication network.

Although illustrated in FIG. 1 as including a single computing device 14 executing contract assessment tool 16, network system 10 may comprise a centralized or distributed system of computing devices, such as desktop computers, laptops, workstations, wireless devices, cloud-based compute nodes, network-ready appliances, file servers, print servers, or other devices, configured to execute and/or support all or a portion of contract assessment tool 16. For example, network system 10 includes database 26, which may include a plurality of databases, data centers, public or private cloud systems, and other storage facilities in which third party provider contracts, governing documents, and other contract negotiation information are stored.

Agent devices 12, legal group devices 18, LOB devices 20, and executive devices 22 may each comprise any of a wide range of user devices, including laptop or desktop computers, tablet computers, so-called “smart” phones, “smart” pads, “smart” watches, Internet of Things (IoT) devices, or other personal digital appliances equipped for wired or wireless communication. Each of agent devices 12, legal group devices 18, LOB devices 20, and executive devices 22 may include at least one user interface device (not shown) that enables a user of the respective computing device to interact with the computing device. In some examples, the user interface devices of agent devices 12, legal group devices 18, LOB devices 20, and executive devices 22 may be configured to receive tactile, audio, or visual input. In addition to receiving input from the user, the user interface devices of agent devices 12, legal group devices 18, LOB devices 20, and executive devices 22 may be configured to output content such as a graphical user interface (GUI) for display, e.g., at a display device associated with the respective computing device.

In accordance with techniques described in this disclosure, one of agent devices 12 initiates an assessment session with contract assessment tool 16 executing on computing device 14 for a contract being negotiated with a third party provider. During the assessment session, the one of agent devices 12 has access to contract negotiation information for the contract. In this way, contract assessment tool 16 provides a source of contract negotiation information for the contract that is accessible by an enterprise agent operating the one of agent devices 12. The agent may be responsible for contract creation with the third party provider associated with third party provider devices 24 to provide a product or service requested by an enterprise LOB associated with LOB devices 20. In general, the agents responsible for contract creation may also be referred to herein as consultants or supply chain consultants.

Contract assessment tool 16 is configured to guide the agent operating the one of agent devices 12 through a contract creation process for the contract being negotiated with the third party provider associated with one of third party provider devices 24. Contract assessment tool 16 provides the one of agent devices 12 with access to the contract negotiation information for the contract. Contract assessment tool 16 presents one or more prompts via the one of agent devices 12 for input data representative of information related to the contract, automatically determines whether negotiations for the contract are to be escalated to an enterprise legal group associated with legal group devices 18 based on the information related to the contract, and automatically generates one or more reports associated with the contract based on the information related to the contract. In various examples, contract assessment tool 16 may provide user-friendly customizable logic (e.g., formulas and macroinstructions) such that assessments, prompts, identifications, reports, and notifications (among other features) may by customized for the specific needs of a particular enterprise LOB.

Contract assessment tool 16 may output the one or more reports to at least one of legal group devices 18, LOB devices 20, and executive devices 22. For example, in the case where a legal escalation is triggered, contract assessment tool 16 may generate a legal report that includes a legal intake form and a package of supporting information, and output the legal report to one or more of legal group devices 18. As another example in the case where certain conditions are present for the contract (e.g., high risk or high value), contract assessment tool 16 may generate an executive report that includes an executive briefing, and output the executive report to one or more of executive devices 22 associated with one or more enterprise executives for approval of the contract. As a further example, contract assessment tool 16 may generate a summary report that includes an engagement summary, and output the summary report to one or more of LOB devices 20 associated with the enterprise LOB that requested the product or service that is covered by the contract.

Upon the one of agent devices 12 terminating the assessment session for the contract with contract assessment tool 16, computing device 14 may store the contract negotiation information as received and determined for the contract during the assessment session, e.g., in database 26. In some examples, the one of agent devices 12 may terminate the assessment session upon completion of the contract assessment and generation of the one or more reports. In other examples, the one of agent devices 12 may terminate the assessment session at any time while the contract assessment is partially complete such that the same agent device or a different agent device of agent devices 12 may access the contract negation information for the contract during a subsequent assessment session for the contract with contract assessment tool 16. In this way, the agent operating the one of agent devices 12 may begin a contract assessment for the contract during a first assessment session with contract assessment tool 16 and complete the contract assessment, update the data used for the contract assessment, or hand-off the contract assessment to another agent operating another of agent devices 12 for completion and/or updating during one or more subsequent assessment sessions with contract assessment tool 16.

Contract assessment tool 16 may comprise a software application executing on computing device 14 that generates data representative of a user interface (e.g., a GUI) for display on agent devices 12 through which the enterprise agents operating agent devices 12 may view and modify the contract negotiation information for the contract. In some examples, to present the one or more prompts to the agent device 12, contract assessment tool 16 generates data representative of one or more fillable fields for each corresponding prompt of the one or more prompts for display on agent device 12 as part of the user interface. Contract assessment tool 16 may then receive input data representative of the information related to the contract from the agent device 12 as one or more inputs to the fillable fields of the user interface designed to capture the information responsive to the corresponding prompt.

Although illustrated in FIG. 1 as being executed locally on computing device 14, in other examples contract assessment tool 16 may comprise a cloud-hosted application on a cloud platform that may be integrated with software-as-a-service (SaaS) providers. In this example, computing device 14 may make requests to the cloud-hosted contract assessment tool to initiate, participate in, and/or terminate an assessment session on behalf of one of agent devices 12. Continuing this example, computing device 14 may receive the one or more reports output by the cloud-based contract assessment tool, and may distribute the reports to the appropriate one of legal group devices 18, LOB devices 20, and executive devices 22.

As one specific example, contract assessment tool 16 may comprise a workbook in a spreadsheet application (e.g., Microsoft Excel) using both formulas and macroinstructions (macros) executing on computing device 14. In this specific example, the workbook may be designed in a way that locks and/or hides certain of the fillable fields (e.g., cells/rows/tabs) until they are needed to receive information related to the contract from agent devices 12. The design of the workbook may enable the ability to guide the executive agents through the contract creation process, and may provide a clean look and feel, consistent data, consistent outputs, and a consistent process. In addition, the design of the workbook may allow for easy modifications to reflect changing business needs. Furthermore, the workbook and export of contract assessment tool 16 may be designed to be entirely, or nearly entirely, self-contained. In other words, the agent device 12 may have other programs open, and the workbook and export may not interfere with those other programs. This may be achieved by coding contract assessment tool 16 in a way that specifically identifies the workbook and export as a unique variable that is then referenced throughout the code.

As described herein, contract assessment tool 16 is, in some examples, configured to combine many different functions into a single package and, in some examples, may use a technology product (e.g., a spreadsheet application) that is widely available. Current contract assessment solutions on the market are large costly systems that provide a lower level of functionality and customization compared to that described herein with respect to contract assessment tool 16. More specifically, the current contract assessment systems are expensive, difficult/expensive to customize, and do not provide a single, simple way to provide all the different functionality described herein with respect to contract assessment tool 16.

Contract assessment tool 16 may provide solutions to one or more issues related to current contract assessment solutions. For example, contract assessment tool 16 creates a standard assessment to drive a more consistent assessment of contract gaps, a more consistent escalation process to the enterprise legal group, and more consistent/standard data requested and collected for the contract creation process. As another example, contract assessment tool 16 provides easily customized functionality. Furthermore, the techniques of how the contract assessment tool 16 was designed to be customized may be leveraged to fit multiple business functions that require standardized inputs, assessments, and/or report outputs.

The architecture of network system 10 illustrated in FIG. 1 is shown for exemplary purposes only and should not be limited to this architecture. Network system 10 illustrated in FIG. 1 shows a single computing device 14 executing contract assessment tool 16 in communication with a plurality of agent devices 12, legal group devices 18, LOB devices 20, and executive devices 22 via network 28. In other examples, network system 10 may include multiple different computing devices each executing an instance of contract assessment tool 16 and configured to communicate with multiple different user devices.

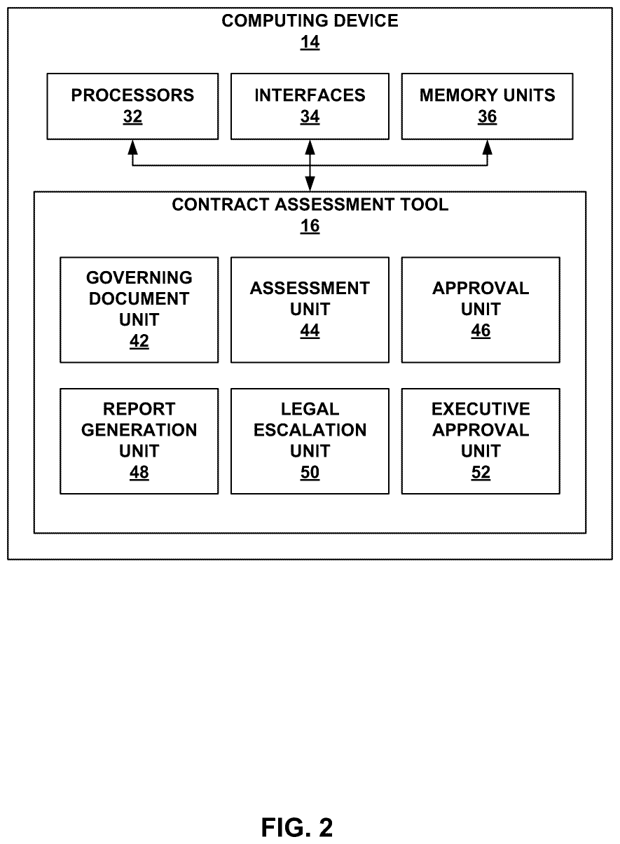

FIG. 2 is a block diagram illustrating an example of computing device 14 executing contract assessment tool 16 from FIG. 1 in greater detail. The architecture of computing device 14 illustrated in FIG. 2 is shown for exemplary purposes only. Computing device 14 should not be limited to the illustrated example architecture. In other examples, computing device 14 may be configured in a variety of ways.

As shown in the example of FIG. 2, computing device 14 includes one or more processors 32, one or more interfaces 34, one or more memory units 36. Computing device 14 also includes contract assessment tool 16, which may be implemented as program instructions and/or data stored in memory units 36 and executable by processors 32 or implemented as one or more hardware units or devices of computing device 14. Memory units 36 of computing device 14 may also store an operating system (not shown) executable by processors 32 to control the operation of components of computing device 14. The components, units, or modules of computing device 14 are coupled (physically, communicatively, and/or operatively) using communication channels for inter-component communications. In some examples, the communication channels may include a system bus, a network connection, an inter-process communication data structure, or any other method for communicating data.

Processors 32, in one example, may comprise one or more processors that are configured to implement functionality and/or process instructions for execution within computing device 14. For example, processors 32 may be capable of processing instructions stored by memory units 36. Processors 32 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory units 36 may be configured to store information within computing device 14 during operation. Memory units 36 may include a computer-readable storage medium or computer-readable storage device. In some examples, memory units 36 include one or more of a short-term memory or a long-term memory. Memory units 36 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory units 36 are used to store program instructions for execution by processors 32. Memory units 36 may be used by software or applications running on computing device 14 (e.g., contract assessment tool 16) to temporarily store information during program execution.

Computing device 14 may utilize interfaces 34 to communicate with external devices via one or more networks, e.g., network system 10 of FIG. 1. Interfaces 34 may be network interfaces, such as Ethernet interfaces, optical transceivers, radio frequency (RF) transceivers, or any other type of devices that can send and receive information. Other examples of such network interfaces may include Wi-Fi or Bluetooth radios. In some examples, computing device 14 utilizes interfaces 34 to wirelessly communicate with external devices, e.g., agent devices 12, legal group devices 18, LOB devices 20, or executive devices 22 of network system 10 from FIG. 1, or other computing devices within network system 10.

In the illustrated example of FIG. 2, contract assessment tool 16 includes a governing document unit 42, an assessment unit 44, and an approval unit 46, a report generation unit 48, a legal escalation unit 50, and an executive approval unit 52. In other examples, contract assessment tool 16 may include more or fewer functional units. For example, although illustrated in FIG. 2 as separate functional units, legal escalation unit 50 and/or executive approval unit 52 may be included within report generation unit 48.

According to the disclosed techniques, contract assessment tool 16 receives a request from an agent device 12 to initiate an assessment session for a contract being negotiated by a third party provider associated with one of third party provider devices 24, and in response, provides the agent device 12 with access to contract negotiation information for the contract. In general, contract assessment tool 16 (or one or more of the units illustrated within contract assessment tool 16) may capture, track, and/or perform one or more of the following: initial assessment information, contract approvals, risk assessments, governing document identification, legal escalation, gap analysis, and/or report generation (e.g., summary reports, executive reports, and/or legal reports including a legal intake form and a gap/governing document analysis).

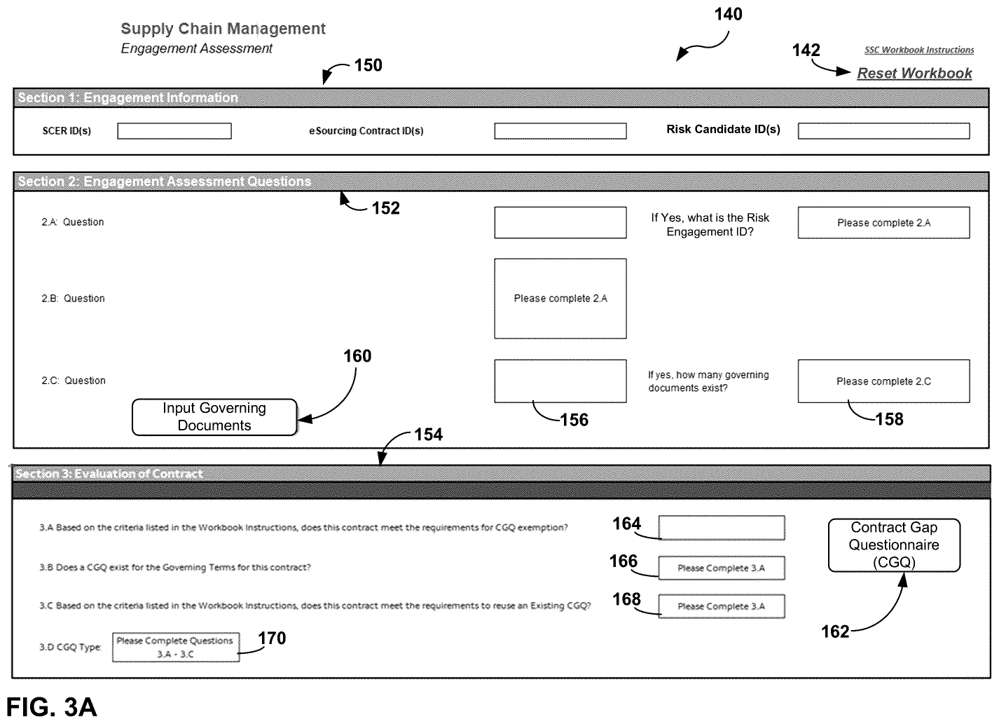

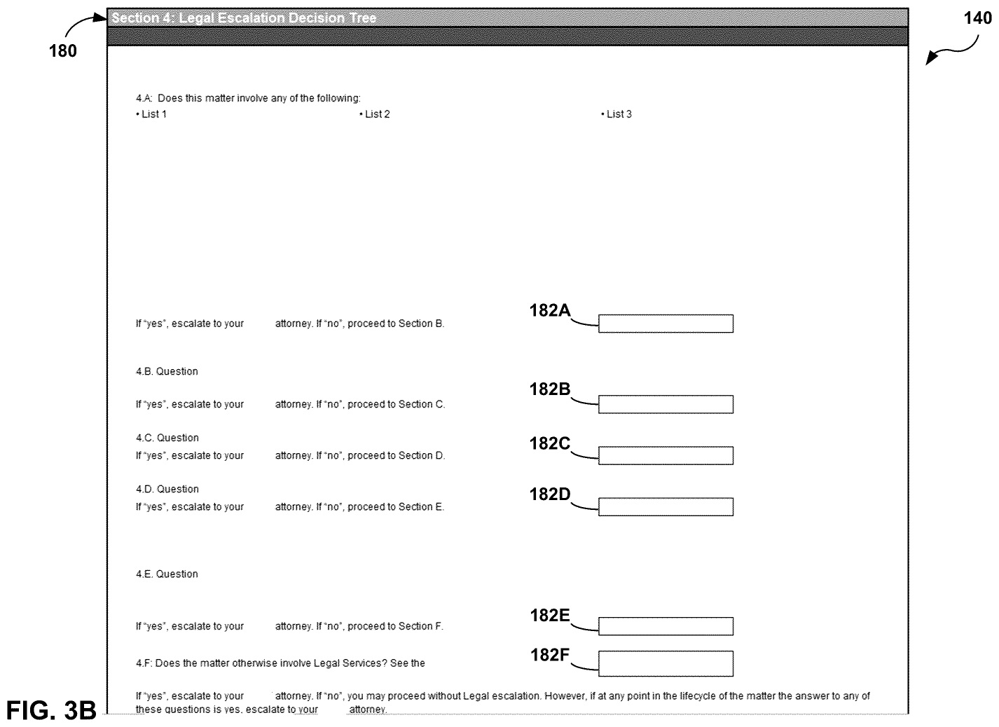

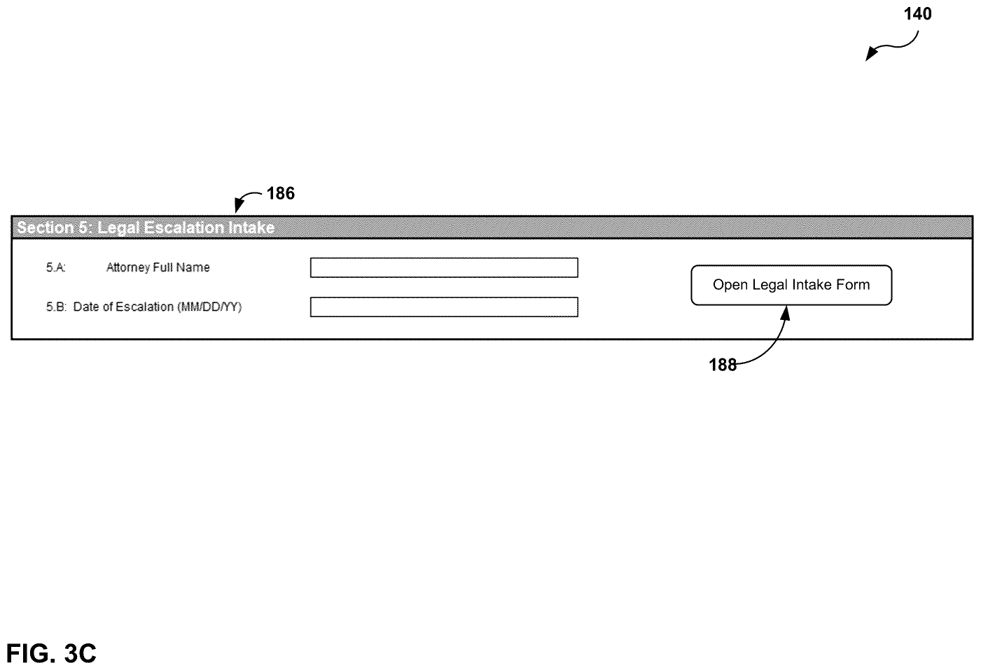

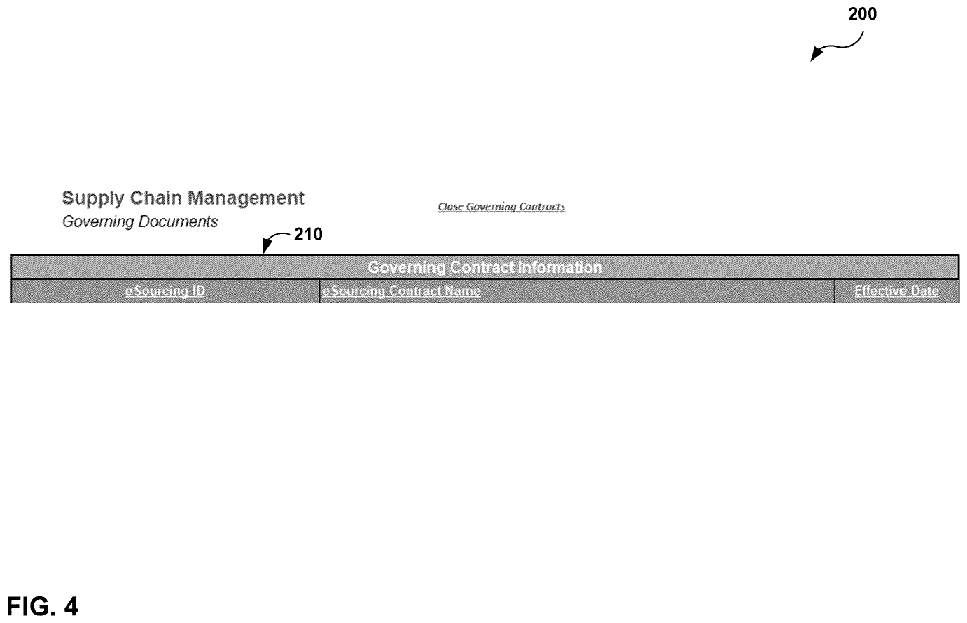

Governing document unit 42 may present prompts to and receive input data from the agent device 12 representative of information related to a number of governing documents for the contract and identification of each of the governing documents. Governing documents may include master contracts, statements of work, other contracts, addendums, attachments, schedules, transaction documents, and the like. In one example, governing document unit 42 may present a first prompt for an indication of the number of governing documents and only present a second prompt for identification of each of the governing documents based on the indicated number of governing documents received in response to the first prompt being greater than zero. Example governing document prompts are illustrated in FIGS. 3A and 4.

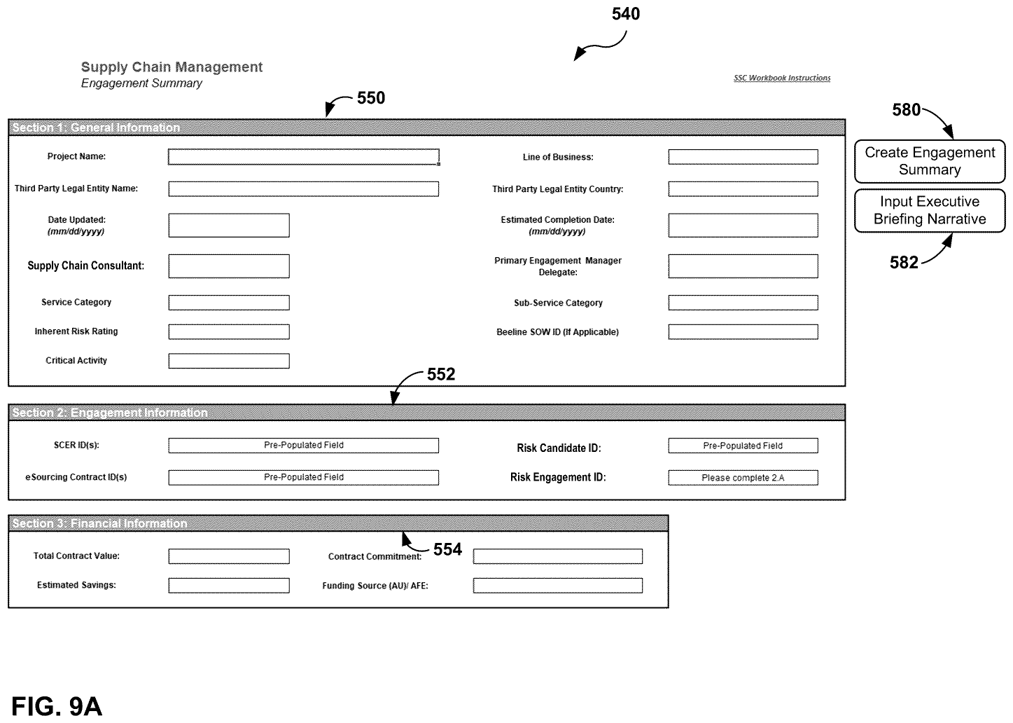

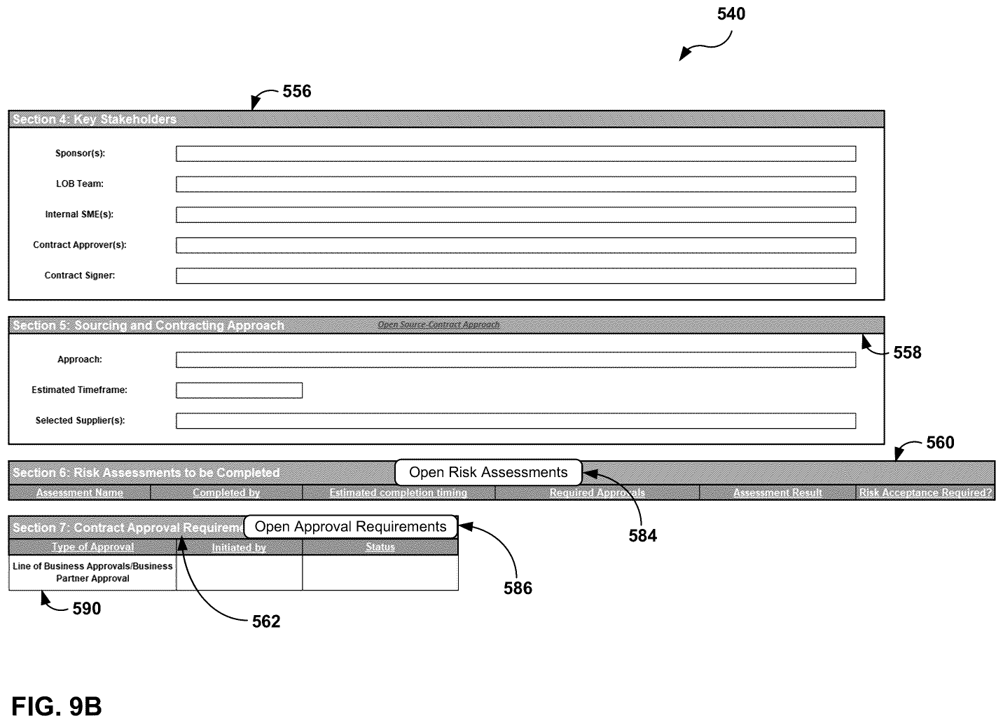

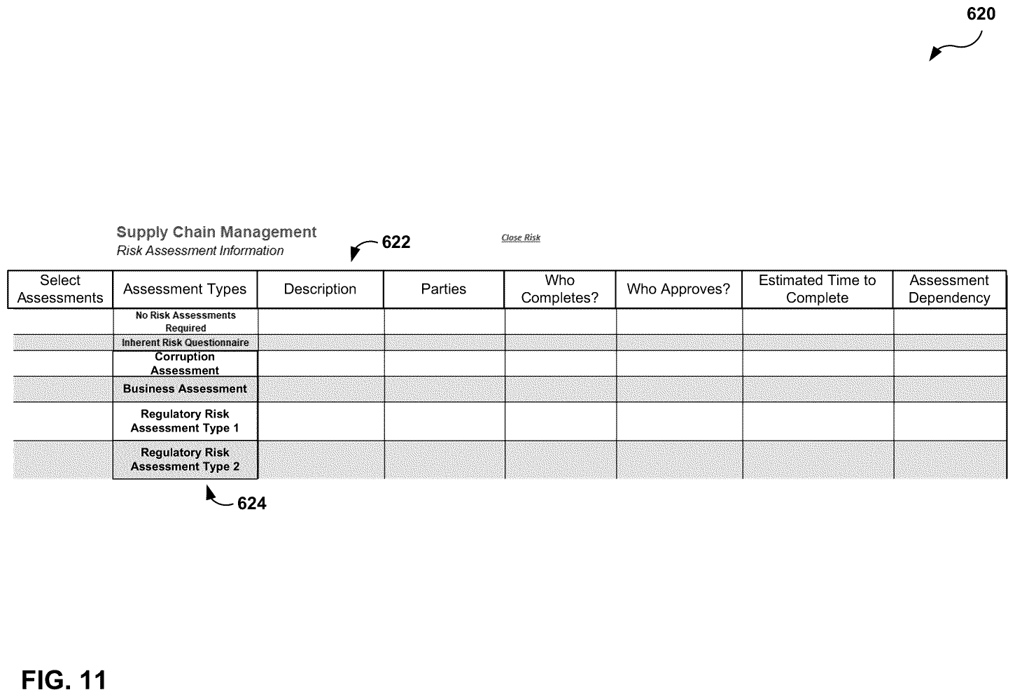

Assessment unit 44 may present prompts to and receive input data from the agent device 12 representative of information related to identification of one or more risk assessments to be performed for the contract and any status updates for the identified risk assessments. In one example, assessment unit 44 may present a prompt to open a risk assessment chart. Assessment unit 44 may then present the risk assessment chart to the agent device 12, where the risk assessment chart is configured to receive identification of the one or more risk assessments to be performed for the contract. The risk assessment chart is also configured to receive status updates (e.g., who completes the assessment, who approves the assessment, an estimated time to completion of the assessment, or assessment completed) for each of the identified risk assessments. Example risk assessment prompts are illustrated in FIGS. 9B and 11.

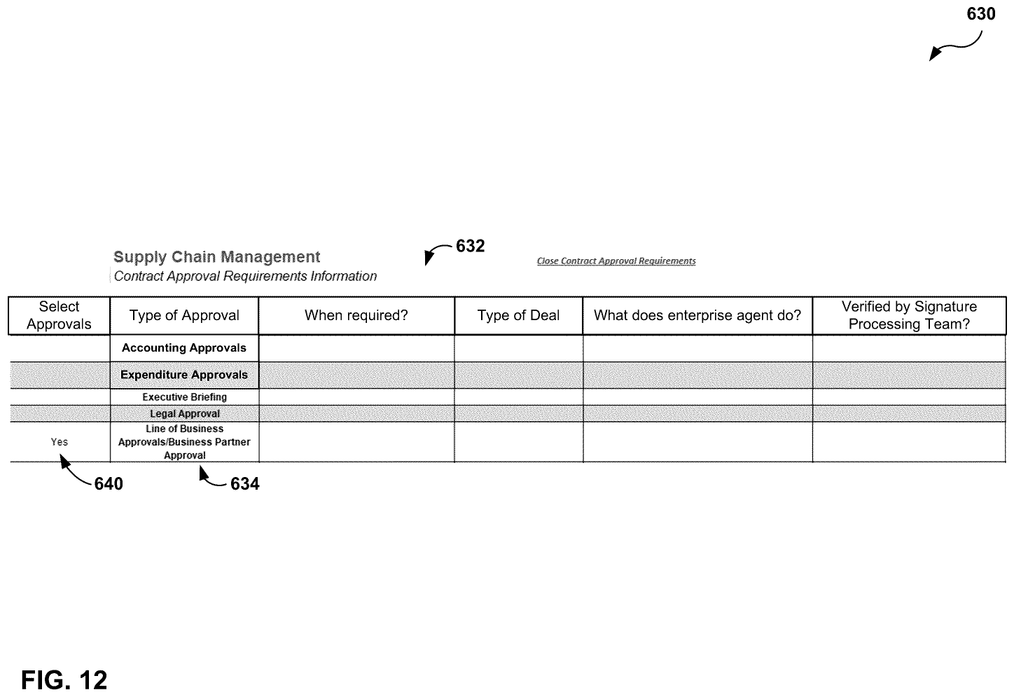

Approval unit 46 may present prompts to and receive input data from the agent device 12 representative of information related to identification of one or more approvals required for the contract and any status updates for the identified approvals. In one example, approval unit 46 may present a prompt to open a contract approval requirements chart. Approval unit 46 may then present the contract approval requirements chart to the agent device 12, where the contract approval requirements chart is configured to receive identification of the one or more approvals required for the contract. The contract approval requirements chart is also configured to receive status updates (e.g., when the approval is required or approval received) for each of the identified approvals. Example approval prompts are illustrated in FIGS. 9B and 12.

Report generation unit 48 may automatically generate one or more reports associated with the contract based on the received information related to the contract. Report generation unit 48 may output the one or more reports to at least one of legal group devices 18, LOB devices 20, and executive devices 22. In some examples, report generation unit 48 may automatically generate the one or more reports in an easily distributable file format and form (e.g., a Microsoft Word file that includes a report template). This may provide a benefit in ensuring consistency across the reports and facilitating easy data migration from the reports.

As one example, report generation unit 48 may generate a summary report for the enterprise LOB that requested the product or service that is covered by the contract at any time, e.g., upon request received from the agent device 12. In this example, report generation unit 48 may generate a summary report that includes an engagement summary, and output the summary report to one or more of LOB devices 20 associated with the enterprise LOB. An example engagement summary user interface and associated reporting prompts are illustrated in FIGS. 9A-9B.

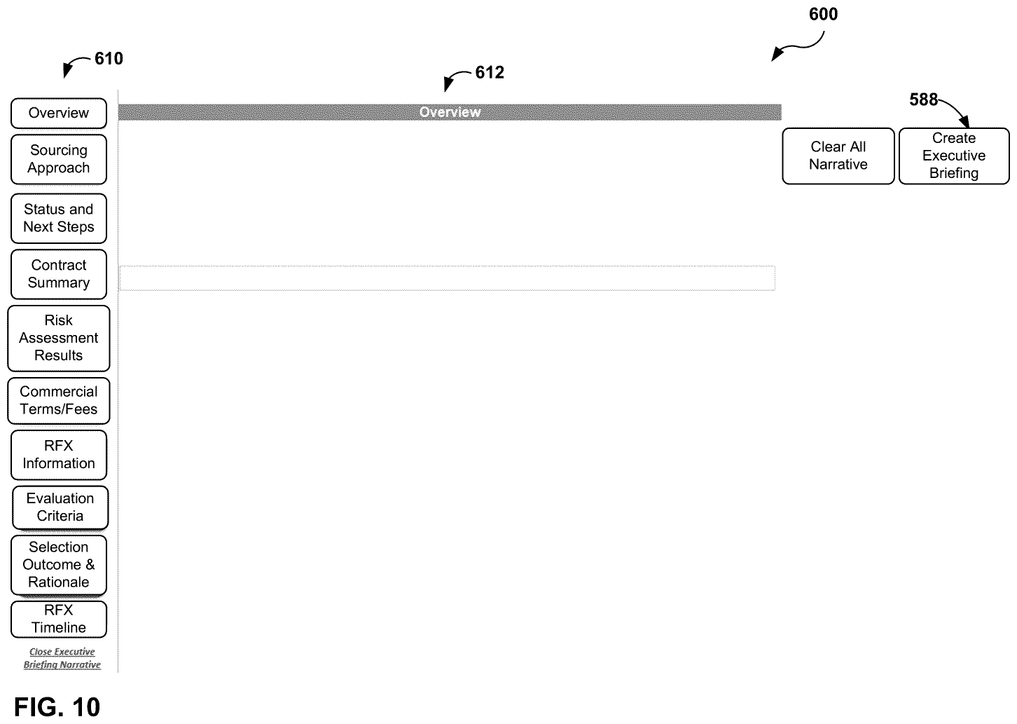

As another example, in the case where executive approval is triggered for the contract, report generation unit 48 may generate an executive report that includes an executive briefing, and output the executive report to one or more of executive devices 22 associated with one or more enterprise executives for approval of the contract. In order to determine whether executive approval of the contract is required, executive approval unit 52 may determine whether certain conditions are present for the contract, such as whether the contract is considered high risk or whether the contract is considered high value. For example, the contract may be considered high risk based a high risk rating indicated by at least one of the identified risk assessments performed for the contract. The contract may be considered high value when a total value of the contract is above a predetermined dollar threshold. The predetermined dollar threshold may be based on the products or services covered by the contract. In some additional examples, executive approval unit 52 may determine whether executive approval of the contract is required based on at least one of the identified approvals required for the contract. An example executive briefing user interface and associated reporting prompts are illustrated in FIGS. 9A and 10.

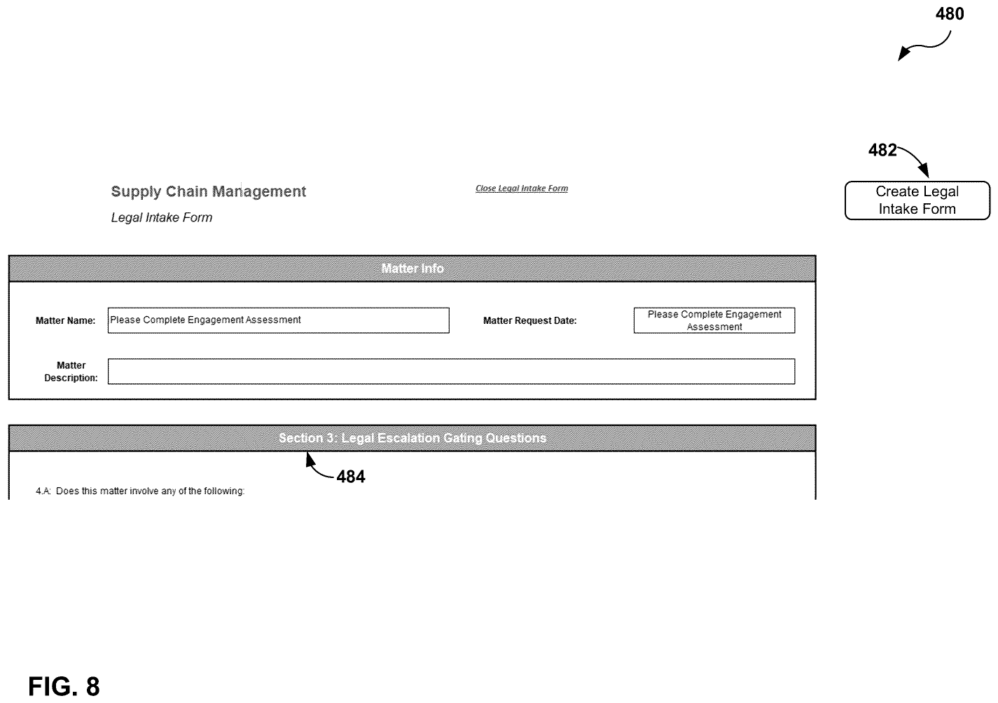

As a further example, in the case where a legal escalation is triggered for the contract, report generation tool 48 may generate a legal report that includes a legal intake form and a package of supporting information, and output the legal report to one or more of legal group devices 18 associated with the enterprise legal group. More specifically, the legal report for the enterprise legal group may include the legal intake form and a gap/governing document analysis including one or more of governing documents, input in response to legal gating prompts, or input in response to contract gap prompts that are bundled together and exported as a single package. Example legal intake form prompts are illustrated in FIGS. 3C and 8.

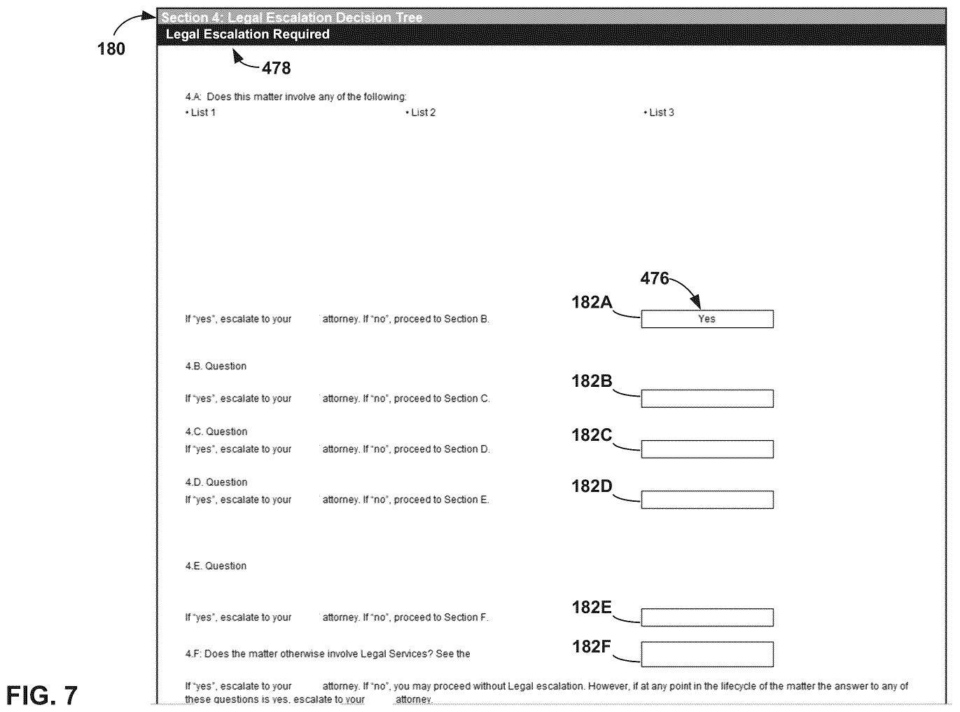

In order to determine whether negotiations for the contract are to be escalated to the enterprise legal group, legal escalation unit 50 may receive input from the agent device 12 in response to legal gating prompts related to the contract. The legal gating prompts may relate to one or more of the governing terms and conditions for the contract (e.g., arbitration, effective date, jurisdiction, etc.), the nature and scope of the contract, and/or the products or services covered by the contract. In the case where the input received in response to the legal gating prompts triggers the legal escalation for the contract, legal escalation unit 50 may notify the enterprise agent operating agent device 12 that negotiations for the contract are to be escalated to the enterprise legal group. Example legal gating prompts and associated notifications are illustrated in FIGS. 3B and 7.

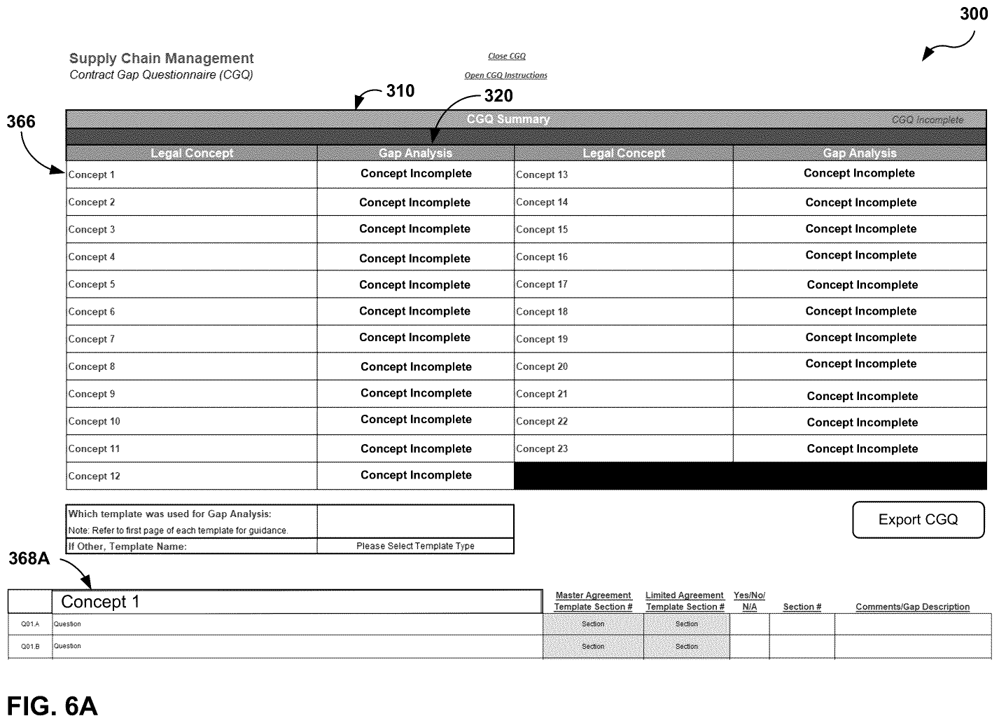

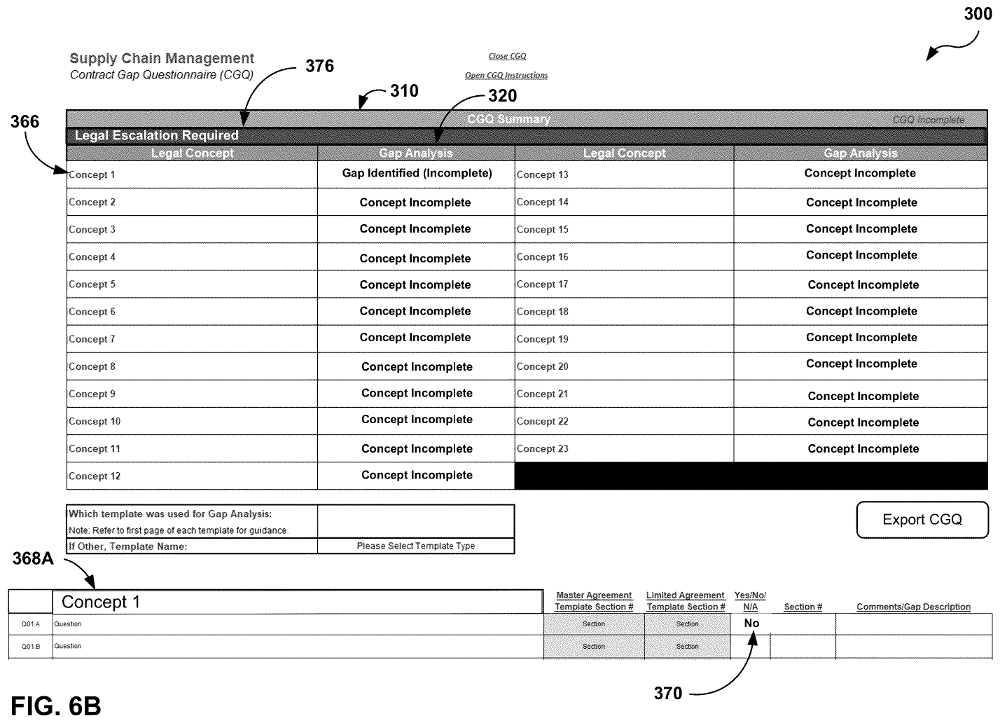

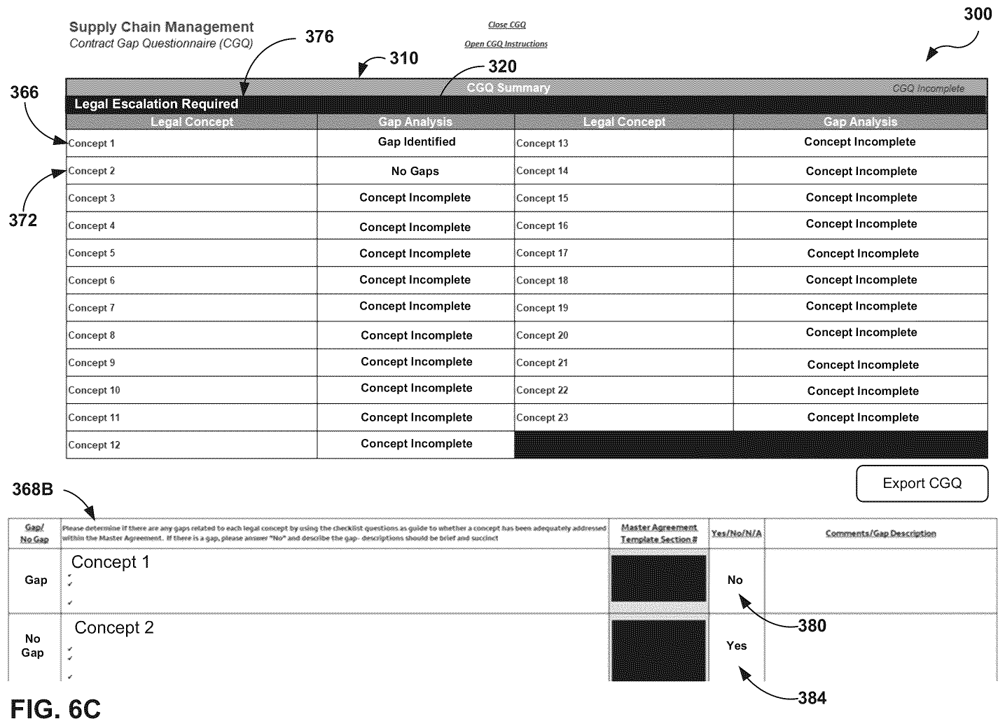

For example, in order to determine whether negotiations for the contract are to be escalated to the enterprise legal group, legal escalation unit 50 may receive input from the agent device 12 in response to a plurality of contract gap prompts indicating whether the contract includes a plurality of preferred terms. The preferred terms comprise terms and/or clauses that the enterprise either prefers or requires to be included in all contracts created with third party providers. Legal escalation unit 50 may present a prompt to open a contract gap questionnaire. Legal escalation unit 50 may then present the contract gap questionnaire to the agent device 12, where the contract gap questionnaire includes a plurality of prompts designed to receive input indicating whether the contract includes each of a plurality of preferred terms for each of a plurality of legal concepts. Based on the input in response to the contract gap questionnaire indicating that the contract does not including at least one of the preferred terms (i.e., the contract includes at least one gap), a legal escalation may be triggered from the contract and legal escalation unit 50 may notify the enterprise agent that negotiations for the contract are to be escalated to the enterprise legal group. Example contract gap prompts and associated notifications are illustrated in FIGS. 3A and 6A-6C.

In some examples, legal escalation unit 50 may notify the enterprise agent that negotiations for the contract are to be escalated to the enterprise legal group by presenting a notification to the agent device 12 as part of a user interface of contract assessment tool 16. In other examples, legal escalation unit 50 may notify the enterprise agent that negotiations for the contract are to be escalated to the enterprise legal group by sending the notification to the agent device 12 via a communication channel different than contract assessment tool 16.

FIGS. 3A-3C illustrate an example engagement assessment user interface 140 generated by contract assessment tool 16 for display on agent device 12, in accordance with the techniques of this disclosure. The engagement assessment user interface 140 guides the enterprise agent through the contracting process, including gathering information about the contract, evaluating the contract, and determining whether legal escalation is required.

FIG. 3A illustrates a portion of the engagement assessment user interface 140 including three sections 150, 152, and 154, and a “reset workbook” link 142. In response to the selection of “reset workbook” link 142 by agent device 12, computing device 14 may re-initialize all variables that are referenced in the code for contract assessment tool 16, re-calculate all ranges that are called in the code for contract assessment tool 16, and/or unlock any required input fields that may have been locked accidentally by the agent operating agent device 12.

The three sections of engagement assessment user interface 140 illustrated in FIG. 3A include Section 1: engagement information section 150, Section 2: engagement assessment questions section 152, and Section 3: evaluation of contract section 154. Engagement information section 150 includes prompts and fillable fields designed to receive unique identifiers associated with a current contract being negotiated. Data entered in the fillable fields in engagement information section 150 automatically feeds the engagement summary user interface 540 illustrated in FIGS. 9A-9B and the executive briefing user interface 600 illustrated in FIG. 10.

Engagement assessment questions section 152 includes prompts and fillable fields designed to receive information used to facilitate initial research to identify any existing contracts, e.g., with a same third party provider and/or for a same product or service covered by the current contract. The research may inform the enterprise agent of the expected work effort to create the contract with the third party provider for the product or service requested by the enterprise LOB. Data entered in the fillable fields in Section 2 automatically feeds the engagement summary user interface 540 illustrated in FIGS. 9A-9B, the executive briefing user interface 600 illustrated in FIG. 10, and if applicable, the contract gap questionnaire illustrated in FIGS. 6A-6C.

In the illustrated example of FIG. 3A, engagement assessment questions section 152 includes several fields with prefilled text that reads “Please complete 2.A,” and “Please complete 2.C.” These fields are examples of locked and/or hidden fillable fields that only unlock and/or become visible to receive input from agent device 12 based on previous information input to other fields. As one example, the fields marked with “Please complete 2.A,” may be unlocked based on the information received in response to prompt 2.A being “yes.”

As another example, the field 158 marked with “Please complete 2.C,” may be unlocked based on the information received in response to prompt 2.C 156 being “yes.” The unlocked field 158 may then receive an indication of a number of governing documents for the contract. In addition, based on the indicated number of governing documents being greater than zero, an “Input Governing Documents” button 160 may also be unlocked. In response to the selection of “Input Governing Documents” button 160 by agent device 12, a governing documents user interface may be presented to agent device 12.

FIG. 4 illustrates an example governing documents user interface 200 generated by contract assessment tool 16 for display on agent device 12, in accordance with the techniques of this disclosure. The governing documents user interface 200 may present a governing documents chart 210 configured to receive identification of each of the governing documents for the contract up to the indicated number of governing documents in field 158 from engagement assessment questions section 152 of the engagement assessment user interface 140 illustrated in FIG. 3A. Although the example user interface 200 shown in FIG. 4 does not illustrate any governing documents, the user interface 200 of FIG. 4 may, in other examples, include a table 210 listing one or more governing documents, each described by attributes that may include eSourcing ID, eSourcing Contract Name, and/or Effective Date. Data captured in the governing documents user interface 200 may be used for an overall contract risk analysis and automatically feeds the engagement summary user interface 540 illustrated in FIGS. 9A-9B, the executive briefing user interface 600 illustrated in FIG. 10, and the contract gap questionnaire 300 illustrated in FIGS. 6A-6C.

Returning to FIG. 3A, evaluation of contract section 154 of the engagement assessment user interface 140 includes prompts and fillable fields 164, 166, 168 designed to receive information used to determine whether a contract gap analysis is required for the current contract, and output field 170 designed to present calculated output of a contract gap questionnaire (CGQ) type required for the current contract. More specifically, if the contract gap analysis is required, evaluation of contract section 154 may determine what type of CGQ is required for the current contract, e.g., a new CGQ, a modified CGQ, or a re-used CGQ. Based on a determination that the contract gap analysis is required and the type of CGQ that is required, a “contract gap questionnaire (CGQ)” button 162 may also be unlocked. In response to the selection of “contract gap questionnaire (CGQ)” button 162 by agent device 12, a contract gap questionnaire user interface may be presented to agent device 12, described in more detail with respect to FIGS. 6A-6C.

In the illustrated example of FIG. 3A, evaluation of contract section 154 includes several fields 166, 168 with prefilled text that reads “Please complete 3.A,” and output field 170 with prefilled text that reads “Please complete questions 3.A-3.C.” These fields are examples of locked and/or hidden fields that only unlock and/or become visible to receive input or present output based on previous information input to other fields. As one example, the fields 166, 168 marked with “Please complete 3.A,” may be unlocked based on the input, e.g., “Yes” or “No” received at field 164 in response to input prompt 3.A. Based on logic and the input to one or more of fields 164, 166, and 168, output field 170 may present the calculated output of the CGQ type.

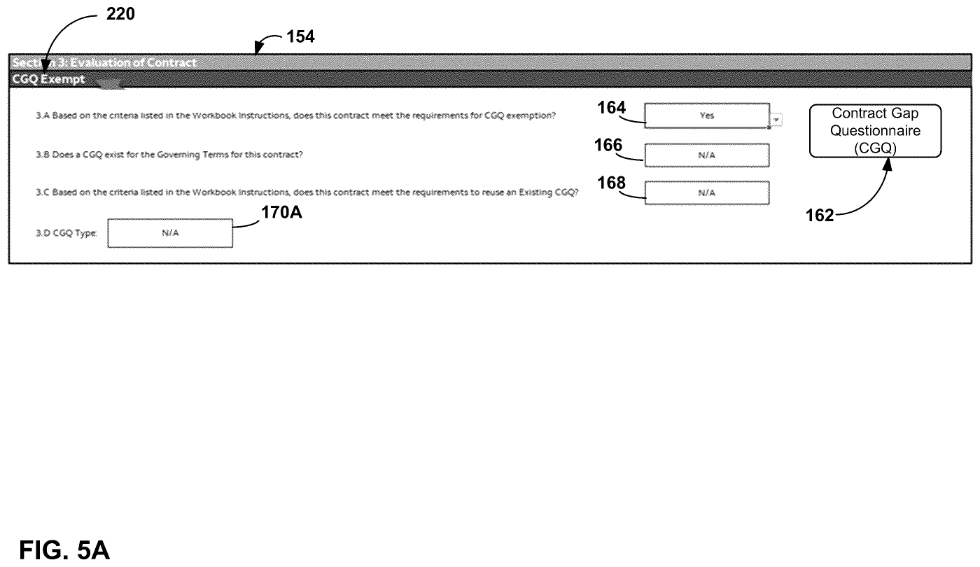

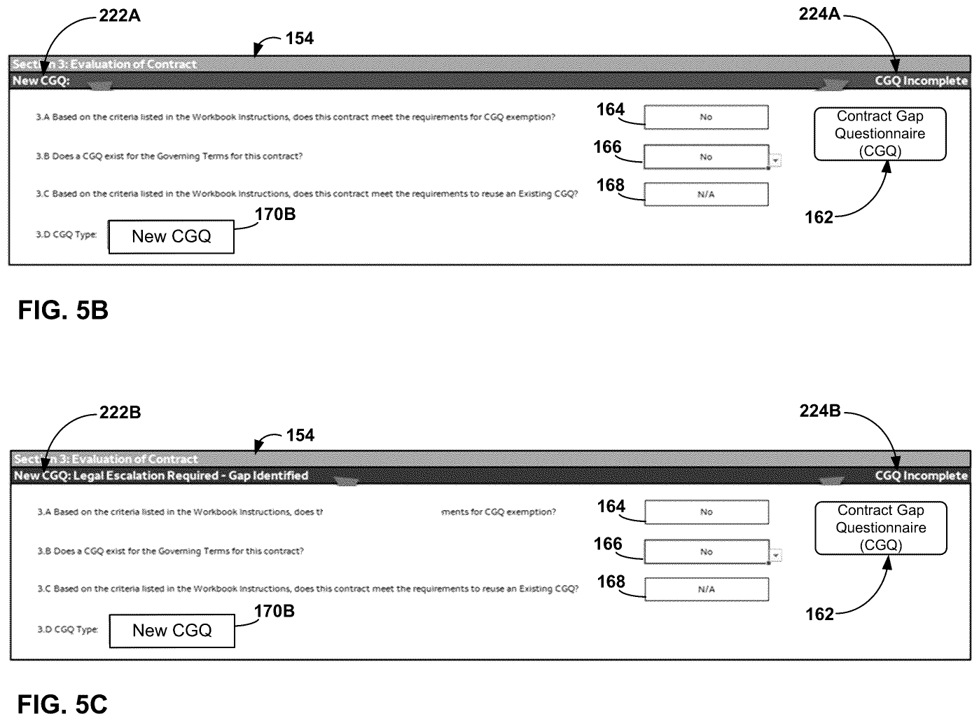

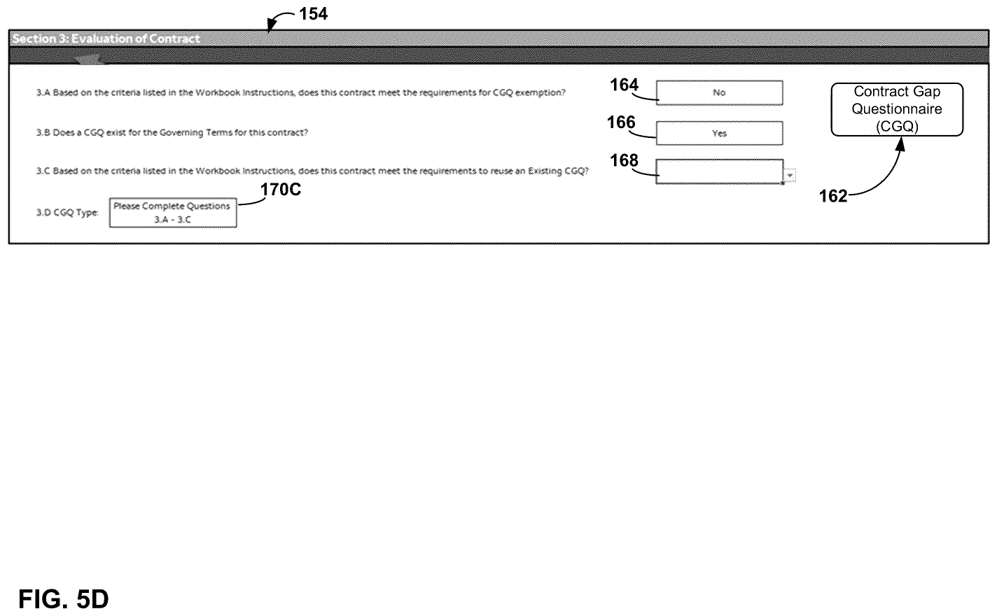

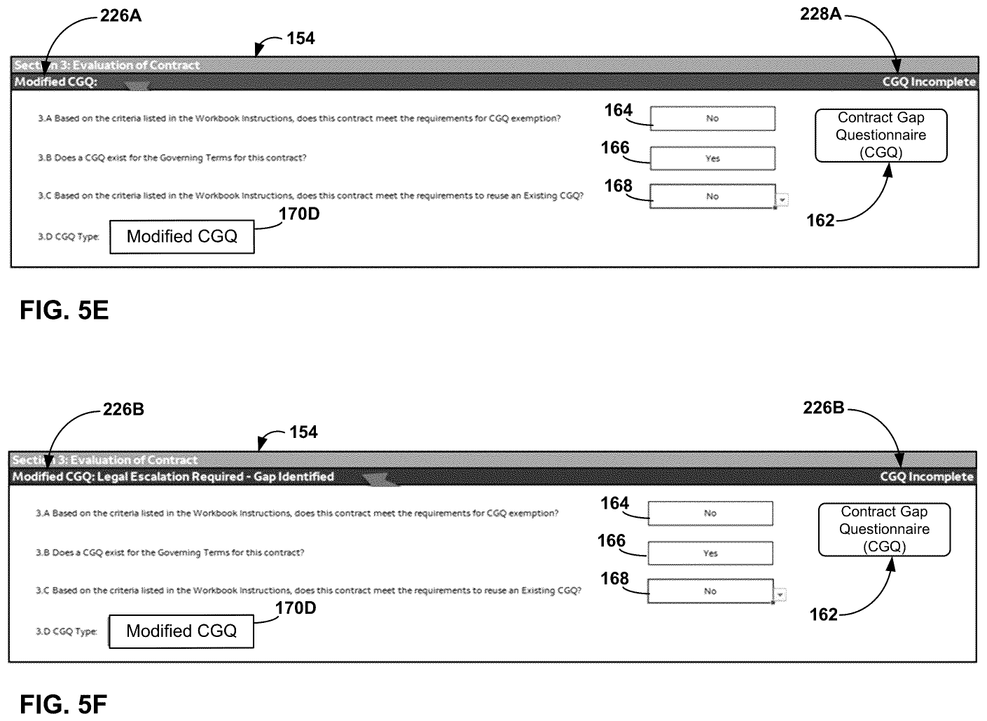

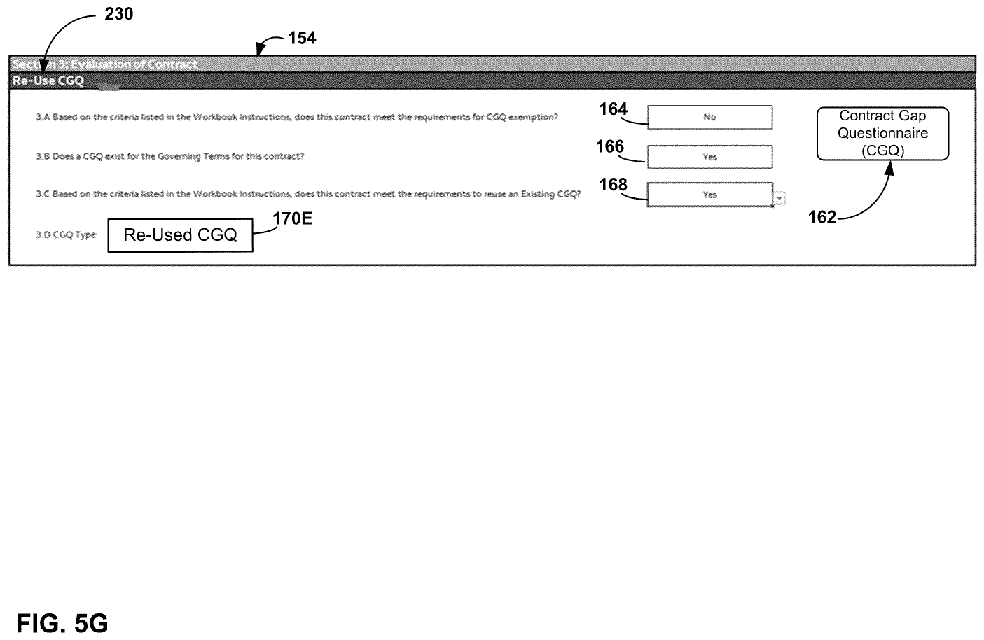

FIGS. 5A-5G illustrate examples of evaluation of contract section 154 of the engagement assessment user interface 140 from FIG. 3A, in accordance with the techniques of this disclosure.

FIG. 5A illustrates an example of the evaluation of contract section 154 in which output field 170A presents “N/A,” indicating that the current contract is CGQ exempt. CGQ exempt means that the current contract meets policy guidance exempting the current contract from requiring a CGQ to be completed. In the example of FIG. 5A, the input to field 164 in response to prompt 3.A is “Yes,” indicating that the current contract meets the requirements for CGQ exemption. The “Yes” input to field 164 makes responses to the following prompts unnecessary such that evaluation of contract section 154 automatically populates fields 166, 168 and 170 with “N/A” and locks fields 166, 168 and 170. In addition, in response to the “Yes” input to field 164, the evaluation of contract section 154 presents a notification 220 of “CGQ Exempt” to the agent device 12.

FIGS. 5B and 5C illustrate examples of the evaluation of contract section 154 in which output field 170B presents “New CGQ,” indicating that a new CGQ is required to be completed for the current contract. New CGQ means that the current contract does not meet policy guidance exempting CGQ completion and there is no previous CGQ on the governing terms for the current contract. In the examples of FIGS. 5B and 5C, the input to field 164 in response to prompt 3.A is “No,” indicating that the current contract does not meet the requirements for CGQ exemption, and the input to field 166 in response to prompt 3.B is “No,” indicating that a CGQ does not exist for the governing terms for the current contract. The “No” inputs to both field 164 and field 166 make a response to the following prompt 3.C unnecessary such that evaluation of contract section 154 automatically populates field 168 with “N/A” and locks field 168. In response, evaluation of contract section 154 automatically populates output field 170B with “New CGQ.”

Based on the determination that a new CGQ is required for the current contract, the “contract gap questionnaire (CGQ)” button 162 is unlocked. Evaluation of contract section 154 may display the results from the CGQ when a gap is identified for the current contract as “Gap Identified,” and may display a status of the CGQ as either “Complete” or “Incomplete.” For example, if there are unanswered CGQ prompts, evaluation of contract section 154 may display “CGQ Incomplete,” and if all questions have been answered, evaluation of contract section 154 may display “CGQ Complete.”

In the illustrated example of FIG. 5B, evaluation of contract section 154 presents a notification 222A of “New CGQ” and presents a notification 224A of “CGQ Incomplete” to the agent device 12. Notifications 222A, 224A indicate that the CGQ for the current contract has no gaps found and is not complete. In the illustrated example of FIG. 5C, evaluation of contract section 154 presents a notification 222B of “New CGQ: Legal Escalation Required-Gap Identified” and presents a notification 224B of “CGQ Incomplete” to the agent device 12. Notifications 222B, 224B indicate that the CGQ for the current contract includes as least one gap and is not complete.

FIG. 5D illustrates an example of the evaluation of contract section 154 in which output field 170C presents “Please complete questions 3.A-3.C,” indicating that the type of CGQ required for the current contract cannot be determined because input to at least one of fields 164, 166, and 168 has not been received. In the example of FIG. 5D, the input to field 164 in response to prompt 3.A is “No,” indicating that the current contract does not meet the requirements for CGQ exemption, and the input to field 166 in response to prompt 3.B is “Yes,” indicating that a CGQ does exist for the governing terms for the current contract. The “Yes” input to field 166 makes a response to the following prompt 3.C necessary for the evaluation of contract section 154 to determine the type of CGQ required for the current contract.

FIGS. 5E and 5F illustrate examples of the evaluation of contract section 154 in which output field 170B presents “Modified CGQ,” indicating that a modified CGQ is required to be completed for the current contract. Modified CGQ means that the current contract does not meet policy guidance exempting CGQ completion, there is a previous CGQ on the governing terms for the current contract, and the CGQ does not meet policy guidelines for re-using. In the examples of FIGS. 5E and 5F, the input to field 164 in response to prompt 3.A is “No,” indicating that the current contract does not meet the requirements for CGQ exemption, the input to field 166 in response to prompt 3.B is “Yes,” indicating that a CGQ does exist for the governing terms for the current contract, and the input to field 168 in response to prompt 3.C is “No,” indicating that the current contract does not meet the requirements to reuse an existing CGQ. In response to the input, evaluation of contract section 154 automatically populates output field 170D with “Modified CGQ.”

Based on the determination that a modified CGQ is required for the current contract, the “contract gap questionnaire (CGQ)” button 162 is unlocked. Evaluation of contract section 154 may display the results from the CGQ and may display a status of the CGQ. In the illustrated example of FIG. 5E, evaluation of contract section 154 presents a notification 226A of “Modified CGQ” and presents a notification 228A of “CGQ Incomplete” to the agent device 12. Notifications 226A, 228A indicate that the CGQ for the current contract has no gaps found and is not complete. In the illustrated example of FIG. 5F, evaluation of contract section 154 presents a notification 226B of “Modified CGQ: Legal Escalation Required-Gap Identified” and presents a notification 228B of “CGQ Incomplete” to the agent device 12. Notifications 226B, 228B indicate that the CGQ for the current contract includes as least one gap and is not complete.

FIG. 5G illustrates an example of the evaluation of contract section 154 in which output field 170E presents “Re-Used CGQ,” indicating that a re-used CGQ is required to be completed for the current contract. RE-used CGQ means that the current contract does not meet policy guidance exempting CGQ completion, there is a previous CGQ on the governing terms for the current contract, and the CGQ does meet policy guidelines for re-using. In the example of FIG. 5G, the input to field 164 in response to prompt 3.A is “No,” indicating that the current contract does not meet the requirements for CGQ exemption, the input to field 166 in response to prompt 3.B is “Yes,” indicating that a CGQ does exist for the governing terms for the current contract, and the input to field 168 in response to prompt 3.C is “Yes,” indicating that the current contract does meet the requirements to reuse an existing CGQ. In response to the input, evaluation of contract section 154 automatically populates output field 170E with “Re-Used CGQ.”

Based on the determination that a re-used CGQ is required for the current contract, the “contract gap questionnaire (CGQ)” button 162 remains locked as a prior CGQ will be re-used in full such that no prompts of a new or modified CGQ need to be answered. In the illustrated example of FIG. 5G, evaluation of contract section 154 presents a notification 230 of “Re-Use CGQ” to the agent device 12.

FIGS. 6A-6C illustrate examples of contract gap questionnaire user interface 300 generated by contract assessment tool 16 for display on agent device 12, in accordance with the techniques of this disclosure. The contract gap questionnaire (CGQ) is a tool used to identify contract language gaps between the current contract and enterprise preferred terms. More specifically, the CGQ may be used to identify gaps between the provisions of the current contract and enterprise requirements for each associated legal concept due to third party risk management, regulatory guidance, legal or regulatory requirements, or enterprise policies and procedures.

FIG. 6A illustrates an example of a blank CGQ. As shown in FIG. 6A, the CGQ user interface 300 includes a CGQ summary 310 in which the contract gap analysis 320 is broken down by legal concept to present the status of the legal concept, e.g., whether the legal concept has all questions answered and whether a gap was identified. In the example of FIG. 6A, the gap analysis 320 for Legal Concept 1 366 is indicated as “Concept Incomplete” because the contract gap prompts or questions for that legal concept have not yet been answered. For each legal concept, the CGQ user interface 300 then presents a plurality of contract gap prompts designed to receive input indicating whether the contract includes a plurality of preferred terms. A portion 368A of the plurality of contract gap prompts for Legal Concept 1 366 is shown in FIG. 6A. In the illustrated example, each of the contract gap prompts included in portion 368A is designed to receive input indicating whether a contract gap is identified and, if a gap is identified, input indicating a particular section of the current contract where the gap was identified and a description of the identified contract gap.

FIG. 6B illustrates an example of a partially complete CGQ. As shown in FIG. 6B, input 370 (“No”) received in response to a first one of the contract gap prompts included in portion 368A indicates that the current contract does not include at least one of the enterprise preferred terms for Legal Concept 1 366. As further illustrated in FIG. 6B, in response to input 370, the CGQ user interface 300 updates the CGQ summary 310 such that gap analysis 320 for Legal Concept 1 366 indicates “Gap Identified (Incomplete)” because only the first contract gap prompt for Legal Concept 1 366 has been answered and indicates at least one gap in the contract. In addition, in response to input 370, the CGQ user interface 300 presents a notification 376 of “Legal Escalation Required” to the agent device 12. In other examples, gap analysis 320 may be updated to indicate “Gap Identified (Complete)” or “No Gaps (Complete)” for a particular legal concept once all of the contract gap prompts for the legal concepts have been answered.

As one example of contract assessment tool 16 providing easily customized functionality, the CGQ user interface illustrated in FIGS. 6A-6C enables the addition or removal of one or more contract gap prompts for an associated legal concept without disrupting data analysis performed by contract assessment tool 16 to update the gap analysis for each legal concept in the CGQ summary. For example, each contract gap prompt for the associated legal concept may be tagged with an identifier unique to the associated legal concept. Contract assessment tool 16 may then be configured to update the gap analysis for the associated legal concept in the CGQ summary by analyzing the input in response to all contract gap prompts having the unique identifier for the associated legal concept. That is, the gap analysis for a corresponding legal concept may automatically (and/or dynamically) update responsive to one or more contract gap prompts having the unique identifier for the corresponding legal concept being independently added, removed, or edited. This functionality may be especially useful for the CGQ user interface as the contract gap prompts included in the CGQ may change frequently.

FIG. 6C illustrates another example of a partially complete CGQ. Unlike FIGS. 6A and 6B, CGQ user interface 300 in FIG. 6C presents, for each legal concept, a single, holistic contract gap prompt designed to receive input indicating whether the contract includes the preferred terms. A portion of table 368B illustrating the contract gap prompt for each of Legal Concept 1 366 and Legal Concept 2 372 is shown in FIG. 6C. In the illustrated example, each of the contract gap prompts included in portion 368B is designed to receive input indicating whether a contract gap is identified for the respective legal concept and, if a gap is identified, a description of the identified contract gap.

As shown in FIG. 6C, input 380 (“No”) received in response to the contract gap prompt for Legal Concept 1 366 included in portion 368B indicates that the current contract does not include at least one of the enterprise preferred terms for Legal Concept 1 366. On the contrary, input 384 (“Yes”) received in response to the contract gap prompt for Legal Concept 2 372 included in portion 368B indicates that the current contract includes the enterprise preferred terms for Legal Concept 2 372.

As further illustrated in FIG. 6C, in response to input 380, the CGQ user interface 300 updates the CGQ summary 310 such that gap analysis 320 for Legal Concept 1 366 indicates “Gap Identified.” In response to input 384, the CGQ user interface 300 updates the CGQ summary 310 such that gap analysis 320 for Legal Concept 2 372 indicates “No Gaps.” In addition, in response to input 380, the CGQ user interface 300 presents a notification 376 of “Legal Escalation Required” to the agent device 12.

FIG. 3B illustrates a fourth section of the engagement assessment user interface 140, Section 4: legal escalation decision tree 180. Legal escalation decision tree 180 includes legal gating prompts and fillable fields 182A-182F designed to receive information used to determine when negotiations for the current contract should be escalated to the enterprise legal group for review and guidance.

FIG. 7 illustrates an example legal escalation notification 478 as part of legal escalation decision tree 180 of the engagement assessment user interface 140 from FIG. 3B, in accordance with the techniques of this disclosure. As one example, if input received in response to any of the legal gating prompts via fillable fields 182A-182F is “yes,” then legal escalation is triggered. As shown in FIG. 7, input 476 (“Yes”) received via fillable field 182A in response to a first one of the legal gating prompts indicates that a legal escalation is triggered. In response to input 476, legal escalation decision tree 180 of the engagement assessment user interface 140 presents notification 478 of “Legal Escalation Required” to the agent device 12.

FIG. 3C illustrates a fifth section of the engagement assessment user interface 140, Section 5: legal escalation intake 186. Legal escalation intake 186 includes prompts and fillable fields designed to receive information used to initiate a legal escalation process based on a determination that negotiations for the current contract should be escalated to the enterprise legal group. In some examples, the fillable fields in legal escalation intake 186 may only be unlocked based on a determination that a legal escalation is triggered as indicated by input in response to the legal gating prompts in legal escalation decision tree 180 of the engagement assessment user interface 140 (illustrated in FIG. 7) and/or input in response to the contract gap prompts in the CGQ user interface 300 (illustrated in FIGS. 6B or 6C). In addition, based on the determination that a legal escalation is triggered, a “Open Legal Intake Form” button 188 may be unlocked. In response to the selection of “Open Legal Intake Form” button 188 by agent device 12, a legal intake form user interface may be presented to agent device 12.

FIG. 8 illustrates an example legal intake form user interface 480 generated by contract assessment tool 16 for display on agent device 12, in accordance with the techniques of this disclosure. The legal intake form user interface 480 may pre-populate data from various sources within contract assessment tool 16, such as the engagement assessment user interface 140 illustrated in FIGS. 3A-3C, the governing documents user interface 200 illustrated in FIG. 4, and the engagement summary user interface 540 illustrated in FIGS. 9A-9B. In particular, as illustrated in FIG. 8, the legal intake form user interface 480 may pre-populate a legal escalation gating questions section 484 with data from the legal escalation decision tree section 180 of the engagement assessment user interface 140 illustrated in FIG. 3B and FIG. 7.

In response to selection of a “Create Legal Intake Form” button 482 by agent device 12, contract assessment tool 16 automatically generates a legal report for the enterprise legal group that includes the legal intake form and a package of supporting information. More specifically, the legal report for the enterprise legal group may include the legal intake form and a gap/governing document analysis including one or more of the identified governing documents, the input in response to the legal gating prompts, or the input in response to the contract gap prompts that are bundled together and exported as a single package.

FIGS. 9A-9B illustrate an example engagement summary user interface 540 generated by contract assessment tool 16 for display on agent device 12, in accordance with the techniques of this disclosure. Contract assessment tool 16 may automatically generate a summary report for the enterprise LOB that requested the current contract engagement at any time, e.g., upon request received from the agent device 12. In addition, in the case where executive approval is triggered for the current contract, contract assessment tool 16 may automatically generate an executive report for the enterprise executives for approval of the current contract. The engagement summary user interface 540, together with data from the engagement assessment user interface 140 illustrated in FIGS. 3A-3C, may be used by contract assessment tool 16 to generate both the summary reports for the enterprise LOB project updates and the executive reports for the enterprise executive briefings.

FIG. 9A illustrates three sections of the engagement summary user interface 540, including Section 1: general information section 550, Section 2: engagement information section 552, and Section 3: financial information section 554. General information section 550 includes prompts and fillable fields designed to receive basic information about the current contract. Engagement information section 552 includes prompts and fillable fields designed to receive the unique identifiers associated with a current contract being negotiated (which may be pre-populated with data from the engagement information section 150 of the engagement assessment user interface 140 illustrated in FIG. 3A). Financial information section 554 includes prompts and fillable fields designed to receive financial information about the current contract, including a total contract value.

The engagement summary user interface 540 illustrated in FIG. 9A also includes a “Create Engagement Summary” button 580. In response to selection of the “Create Engagement Summary” button 580 by agent device 12, contract assessment tool 16 automatically generates the summary report for the enterprise LOB that includes the data from the engagement summary user interface 540. The engagement summary report may be used to communicate key activities and estimated completion timing for the current contract. As the engagement summary user interface 540 is updated through the contract creation process, contract assessment tool 16 may generate an updated executive summary report for the enterprise LOB in response to a subsequent selection of the “Create Engagement Summary” button 580 by an agent operating agent device 12.

In addition, the engagement summary user interface 540 illustrated in FIG. 9A includes an “Input Executive Briefing Narrative” button 582. In some examples, “Input Executive Briefing Narrative” button 582 may only be unlocked based on a determination that an executive approval is triggered for the current contract as indicated by the total contract value in financial information section 554 of the engagement summary user interface 540 (illustrated in FIG. 9A), the identified risk assessments for the current contract in a risk assessments to be completed section 560 of the engagement summary user interface 540 (illustrated in FIG. 9B), and/or the identified approvals required for the current contract in a contract approval requirements section 562 of the engagement summary user interface 540 (illustrated in FIG. 9B). In response to the selection of “Input Executive Briefing Narrative” button 582 by agent device 12, an executive briefing user interface may be presented to agent device 12.

FIG. 10 illustrates an example executive briefing user interface 600 generated by contract assessment tool 16 for display on agent device 12, in accordance with the techniques of this disclosure. The executive briefing user interface 600 includes guidance in a narrative input window 612 for each narrative section of the executive briefing, selectable by respective narrative section buttons 610. In response to selection of the “Create Executive Briefing” button 588 by an agent operating agent device 12, contract assessment tool 16 automatically generates the executive report for the enterprise executives that includes the executive briefing along with the data from the engagement summary user interface 580.

FIG. 9B illustrates four additional sections of the engagement summary user interface, including Section 4: key stakeholders section 556, Section 5: sourcing and contracting approach section 558, Section 6: risk assessments to be completed section 560, and Section 7: contract approval requirement section 562. Key stakeholders section 556 includes prompts and fillable fields designed to receive identification of key stakeholders and enterprise team members who will play an active role in getting the current contract executed. Sourcing and contracting approach section 558 includes prompts and fillable fields designed to receive identification of a sourcing and contracting approach for the current contract and an estimated timeframe for executing the sourcing and contracting approach.

Risk assessments to be completed section 560 includes a prompt in the form of an “Open Risk Assessments” button 584. In response to the selection of “Open Risk Assessments” button 584 by agent device 12, a risk assessment information user interface may be presented to agent device 12.

FIG. 11 illustrates an example risk assessment information user interface 620 generated by contract assessment tool 16 for display on agent device 12, in accordance with the techniques of this disclosure. As shown in FIG. 11, the risk assessment information user interface 620 presents a risk assessment chart 622 configured to receive identification of the one or more risk assessments to be performed for the current contract selected from the different types of assessments 624. The risk assessment chart 622 is also configured to receive status updates (e.g., who completes the assessment, who approves the assessment, an estimated time to completion of the assessment, or assessment completed) for each of the identified risk assessments. Data captured in the risk assessment information user interface 620 automatically feeds risk assessments to be completed section 560 of the engagement summary user interface 540 illustrated in FIG. 9B.

Returning to FIG. 9B, contract approval requirement section 562 includes a prompt in the form of an “Open Contract Approval Requirements” button 586 and a pre-selected LOB approval 590 required for the current contract. In response to the selection of “Open Contract Approval Requirements” button 586 by an agent operating agent device 12, a contract approval requirements information user interface may be presented to agent device 12.

FIG. 12 illustrates an example contract approval requirements information user interface 630 generated by contract assessment tool 16 for display on agent device 12, in accordance with the techniques of this disclosure. As shown in FIG. 12, the contract approval requirements information user interface 630 presents a contract approval requirements chart 632 configured to receive identification of the one or more approvals required for the contract selected from the different types of approvals 634. The contract approval requirements chart 632 is also configured to receive status updates (e.g., when the approval is required or approval received) for each of the identified approvals. The contract approval requirements chart 632 illustrated in FIG. 12 includes the pre-selection 640 (“Yes”) of the LOB approval from the types of approvals 634 required for the current contract. Data captured in the contract approval requirements information user interface 630 automatically feeds contract approval requirement section 562 of the engagement summary user interface 540 illustrated in FIG. 9B.

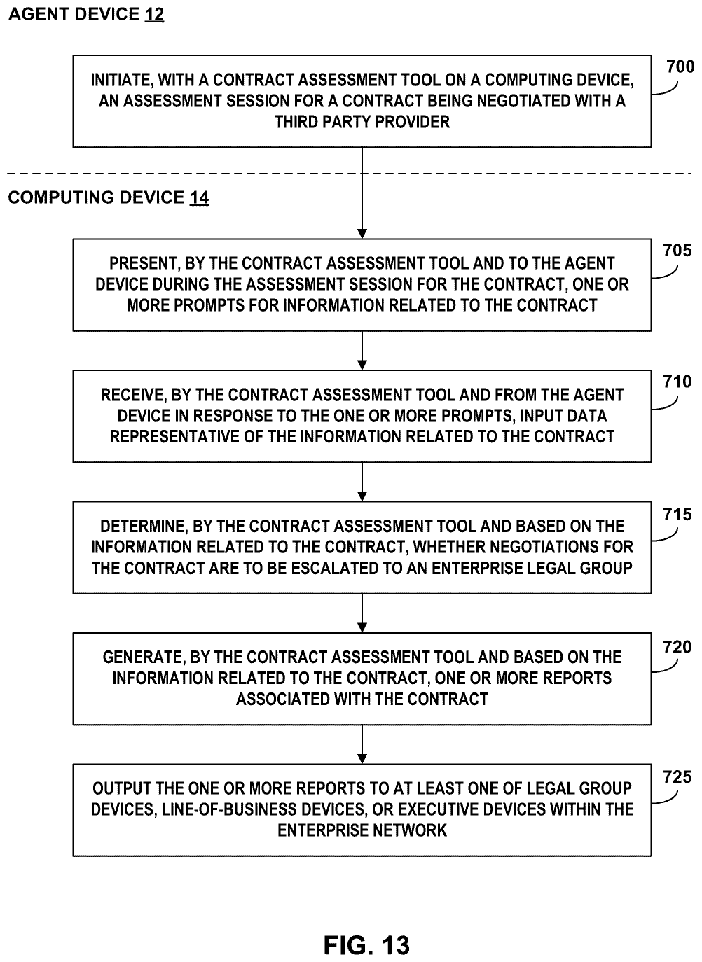

FIG. 13 is a flow diagram illustrating an example operation of a network system including an agent device and a computing device executing the contract assessment tool, in accordance with one or more techniques of this disclosure. The example operation of FIG. 13 is described with respect to one of agent devices 12 from FIG. 1 and computing device 14 executing contract assessment tool 16 from FIGS. 1 and 2.

As seen in the example of FIG. 13, agent device 12 initiates, with contract assessment tool 16 executing on computing device 14, an assessment session for a contract being negotiated with a third party provider, wherein during the assessment session, agent device 12 has access to contract negotiation information for the contract (700). Computing device 14 may present, by the contract assessment tool 16 and to the agent device 12 during the assessment session for the contract, one or more prompts for information related to the contract (705).

Computing device 14 may receive, by the contract assessment tool 16 and from the agent device 12 in response to the one or more prompts, input data representative of the information related to the contract (710). In some examples, computing device 14 may receive an indication of a number of governing documents for the contract in response to a first prompt, and receive identification of each of the governing documents for the contract in response to a second prompt, wherein the second prompt is sent to agent device 12 based on the indicated number of governing documents received in response to the first prompt being greater than zero. In other examples, computing device 14 may receive identification of one or more risk assessments to be performed for the contract in response to a prompt, and subsequently receive any status updates for the identified risk assessments in response to the prompt. In further examples, computing device 14 may receive identification of one or more approvals required for the contract in response to a prompt, and subsequently receive any status updates for the identified approvals in response to the prompt.

Computing device 14 may determine, by the contract assessment tool 16 and based on the information related to the contract, whether negotiations for the contract are to be escalated to an enterprise legal group (715). For example, computing device 14 may receive input data in response to one or more legal gating prompts related to the contract, and based on the received input data triggering a negotiation escalation for the contract, generate a notification that negotiations for the contract are to be escalated to the enterprise legal group.

Computing device 14 may trigger the negotiation escalation for the contract in response to determining that the contract includes at least one gap. As one example, computing device 14 may determine that the contract includes the at least one gap by receiving input data in response to a plurality of contract gap prompts related to whether the contract includes a plurality of preferred terms, and based on the input data indicating that the contract does not include at least one of the preferred terms, triggering the negotiation escalation for the contract. Computing device 14 may then generate the notification that negotiations for the contract are to be escalated to the enterprise legal group, including at least one of: presenting a notification to agent device 12 as part of a user interface of the contract assessment tool 16, or sending the notification to agent device 12 via a communication channel different than the contract assessment tool 16.

Computing device 14 may generate, by the contract assessment tool 16 and based on the information related to the contract, one or more reports associated with the contract (720). Next, computing device 14 may output the one or more reports to at least one of legal group devices 18, line-of-business devices 20, or executive devices 22 within the enterprise network (725). In one example, when negotiations for the contract are to be escalated to the enterprise legal group, computing device 14 generates a legal report including a legal intake form and an analysis including one or more of governing documents, input in response to legal gating prompts, or input in response to contract gap prompts, and outputs the legal report to the legal group devices 18.

In another example, computing device 14 may generate a summary report including an engagement summary, and output the summary report to the line-of-business devices 20, wherein the line-of-business devices 20 are associated with an enterprise line-of-business that requested a product or service from the third party provider that is covered by the contract. In a further example, computing device 14 may determine whether certain conditions are present for the contract, including determining whether the contract is at least one of high risk or high value above a dollar threshold. In the case where the certain conditions are present, computing device 14 generates an executive report including an executive briefing, and outputs the executive report to the executive devices 22 for approval of the contract, wherein the executive devices 22 are associated with enterprise executives.

In some examples, agent device 12 may terminate the assessment session for the contract with the contract assessment tool 16 upon completion of the contract assessment and generation of the one or more reports. In other examples, agent device 12 may terminate the assessment session for the contract with the contract assessment tool 16 at any time while the contract assessment is partially complete such that the same agent device or a different agent device may access the contract negation information for the contract during a subsequent assessment session for the contract with contract assessment tool 16. Upon agent device 12 terminating the assessment session for the contract with contract assessment tool 16, computing device 14 may store the contract negotiation information as received and determined for the contract during the assessment session, e.g., in database 26.

In one example, in response to the initiation of the assessment session for the contract by agent device 12, computing device 14 generates data representative of a user interface of contract assessment tool 16 for display on agent device 12 through which an enterprise agent at least one of views or modifies the contract negotiation information for the contract. In this example, computing device 14 generates data representative of one or more fillable fields for each corresponding prompt of the one or more prompts for display on the agent device 12 as part of the user interface of the contract assessment tool 16, and receives, from the agent device 12, one or more inputs to the fillable fields of the user interface designed to capture the information responsive to the corresponding prompt. In another example, contract assessment tool 16 executing on the computing system 14 comprises a workbook in a spreadsheet application executing on the computing device 14.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method comprising:
initiating, by an agent device of a plurality of agent devices in an enterprise network and with a contract assessment tool executing on a computing device in the enterprise network, an assessment session for a contract being negotiated with a third party provider, wherein during the assessment session, the agent device has access to contract negotiation information for the contract;
generating, by the contract assessment tool during the assessment session for the contract, data representative of a first user interface of a plurality of user interfaces for display by the agent device, wherein the first user interface includes one or more first prompts for first information related to the contract;
receiving, by the contract assessment tool and from the agent device via the one or more prompts included in the first user interface, input data representative of the first information related to the contract;
based on the first information related to the contract, unlocking a button included in the first user interface, wherein the button comprises a visual icon that becomes selectable when unlocked;
based on selection of the unlocked button included in the first user interface, generating, by the contract assessment tool, data representative of a second user interface of the plurality of user interfaces for display by the agent device, wherein the second user interface includes one or more second prompts for second information related to the contract;
determining, by the contract assessment tool and based on the second information related to the contract, that negotiations for the contract are to be escalated to an enterprise legal group;
based on the determination to escalate negotiations for the contract, generating, by the contract assessment tool, a visual notification that legal escalation is required for inclusion in the first user interface and the second user interface for display by the agent device;
generating, by the contract assessment tool and based on the first and second information related to the contract, one or more reports associated with the contract; and
based on the determination to escalate negotiations for the contract, outputting, by the computing device, the one or more reports to of one or more legal group devices within the enterprise network.

2. The method of claim 1, wherein receiving the input data representative of the first information related to the contract comprises receiving an indication of a number of governing documents for the contract in response to a first prompt of the one or more first prompts included in the first user interface;
the method further comprising:
unlocking a second button included in the first user interface based on the indicated number of governing documents received in response to the first prompt being greater than zero;
based on selection of the unlocked second button included in the first user interface, generating a third user interface of the plurality of user interfaces for display by the agent device, wherein the third user interface includes a third prompt for third information related to the contract; and
receiving identification of each of the governing documents for the contract in response to the third prompt.

3. The method of claim 1, further comprising:
generating data representative of a third user interface of the plurality of user interfaces for display by the agent device, wherein the third user interface includes one or more third prompts for third information related to the contract;
receiving identification of one or more risk assessments to be performed for the contract via the one or more third prompts included in the third user interface; and
subsequently receiving any status updates for the identified risk assessments in response to the prompt via the one or more third prompts included in the third user interface.

4. The method of claim 1, further comprising:
generating data representative of a third user interface of the plurality of user interfaces for display by the agent device, wherein the third user interface includes one or more third prompts for third information related to the contract;
receiving identification of one or more approvals required for the contract via the one or more third prompts included in the third user interface; and
subsequently receiving any status updates for the identified approvals via the one or more third prompts included in the third user interface.

5. The method of claim 1, wherein determining that the negotiations for the contract are to be escalated further comprises:
receiving input data representative of third information related to the contract via one or more legal gating prompts included in the first user interface, wherein the received input data triggers a negotiation escalation for the contract; and
based on the received input data triggering the negotiation escalation for the contract, generating the visual notification that legal escalation is required for inclusion in at least the first user interface for display by the agent device.

6. The method of claim 1, wherein determining that the negotiations for the contract are to be escalated comprises determining that the contract includes at least one gap, wherein determining that the contract includes the at least one gap comprises:
receiving input data representative of the second information via the one or more second prompts included in the second user interface, wherein the one or more second prompts comprise prompts related to whether the contract includes a plurality of preferred terms; and
based on the second information indicating that the contract does not include at least one of the preferred terms, triggering a negotiation escalation for the contract.

7. The method of claim 1, wherein generating the visual notification that legal escalation is required further comprises:
sending the visual notification to the agent device via a communication channel different than the contract assessment tool.

8. The method of claim 1, wherein the one or more second prompts comprise one or more contract gap prompts, and wherein generating the one or more reports comprises, when negotiations for the contract are to be escalated to the enterprise legal group, generating a legal report including a legal intake form and an analysis including one or more of governing documents, input in response to legal gating prompts, or input in response to contract gap prompts.

9. The method of claim 1,
wherein generating the one or more reports comprises generating a summary report including an engagement summary; and
wherein outputting the one or more reports comprises outputting the summary report to one or more line-of-business devices, wherein the line-of-business devices are associated with an enterprise line-of-business that requested a product or service from the third party provider that is covered by the contract.

10. The method of claim 1,
wherein generating the one or more reports comprises:
determining whether certain conditions are present for the contract, wherein determining whether the certain conditions are present comprises determining whether the contract is at least one of high risk or high value above a dollar threshold, and
in the case where the certain conditions are present, generating an executive report including an executive briefing; and
wherein outputting the one or more reports comprises outputting the executive report to one or more executive devices for approval of the contract, wherein the executive devices are associated with enterprise executives.

11. The method of claim 1, further comprising:
terminating, by the agent device, the assessment session for the contract with the contract assessment tool; and
storing, by the computing device, the contract negotiation information as received and determined for the contract during the assessment session for access by one of the plurality of agent devices during a subsequent assessment session for the contract with the contract assessment tool.

12. The method of claim 1,
wherein the one or more first prompts for the first information related to the contract comprise one or more first fillable fields for each corresponding prompt of the one or more first prompts for display on the agent device as part of the first user interface of the contract assessment tool, and
wherein receiving the input data representative of the first information related to the contract comprises receiving, from the agent device, one or more inputs to the first fillable fields of the first user interface designed to capture the first information responsive to the corresponding prompt of the one or more first prompts.

13. The method of claim 1, wherein the contract assessment tool executing on the computing device comprises a workbook in a spreadsheet application executing on the computing device.

14. A system comprising:
a plurality of agent devices in an enterprise network, wherein an agent device of the plurality of agent devices is configured to initiate, with a contract assessment tool executing on a computing device in the enterprise network, an assessment session for a contract being negotiated with a third party provider, wherein during the assessment session the agent device has access to contract negotiation information for the contract; and
the computing device communicatively coupled to the one or more agent devices within the enterprise network, the computing device comprising one or more processors executing the contract assessment tool and configured to:
generate, during the assessment session for the contract, data representative of a first user interface of a plurality of user interfaces for display by the agent device, wherein the first user interface includes one or more first prompts for first information related to the contract;
receive, from the agent device via the one or more first prompts included in the first user interface, input data representative of the first information related to the contract;
based on the first information related to the contract, unlock a button included in the first user interface, wherein the button comprises a visual icon that becomes selectable when unlocked;
based on selection of the unlocked button included in the first user interface, generate, by the contract assessment tool, data representative of a second user interface of the plurality of user interfaces for display by the agent device, wherein the second user interface includes one or more second prompts for second information related to the contract;
determine, based on the second information related to the contract, that negotiations for the contract are to be escalated to an enterprise legal group;
based on the determination to escalate negotiations for the contract, generate a visual notification that legal escalation is required for inclusion in the first user interface and the second user interface for display by the agent device;
generate, based on the first and second information related to the contract, one or more reports associated with the contract; and
based on the determination to escalate negotiations for the contract, output the one or more reports to one or more legal group devices within the enterprise network.

15. The system of claim 14, wherein to determine that the negotiations for the contract are to be escalated, the one or more processors of the computing device are configured to:
receive input data representative of third information related to the contract via one or more legal gating prompts included in the first user interface, wherein the received input data triggers a negotiation escalation for the contract; and
based on the received input data triggering the negotiation escalation for the contract, generate the visual notification that legal escalation is required for inclusion in at least the first user interface for display by the agent device.

16. The system of claim 14, wherein to determine that the negotiations for the contract are to be escalated, the one or more processors of the computing device are configured to determine that the contract includes at least one gap, and wherein to determine that the contract includes the at least one gap, the one or more processors of the computing device are configured to:
receive input data representative of the second information via the one or more second prompts included in the second user interface, wherein the one or more second prompts comprise prompts related to whether the contract includes a plurality of preferred terms; and
based on the second information indicating that the contract does not include at least one of the preferred terms, trigger a negotiation escalation for the contract.

17. The system of claim 14, wherein to generate the visual notification that legal escalation is required, the one or more processors are configured to one of:
send the visual notification to the agent device via a communication channel different than the contract assessment tool.

18. The system of claim 14,
wherein the agent device is configured to terminate the assessment session for the contract with the contract assessment tool; and
wherein the one or more processors of the computing device are configured to store the contract negotiation information as received and determined for the contract during the assessment session for access by one of the plurality of agent devices during a subsequent assessment session for the contract with the contract assessment tool.

19. The system of claim 14,
wherein one or more first prompts for the first information related to the contract comprise one or more first fillable fields for each corresponding prompt of the one or more first prompts for display on the agent device as part of the first user interface of the contract assessment tool, and
wherein to receive the input data representative of the first information related to the contract, the one or more processors are configured to receive, from the agent device, one or more inputs to the first fillable fields of the first user interface designed to capture the first information responsive to the corresponding prompt of the one or more first prompts.

20. Computer-readable storage media comprising instructions that, when executed, cause one or more processors to:
initiate, by an agent device in an enterprise network and with a contract assessment tool executing on a computing device in the enterprise network, an assessment session for a contract being negotiated with a third party provider, wherein during the assessment session the agent device has access to contract negotiation information for the contract;
generate, by the contract assessment tool during the assessment session for the contract, data representative of a first user interface of a plurality of user interfaces for display by the agent device, wherein the first user interface includes one or more first prompts for first information related to the contract;
receive, by the contract assessment tool and from the agent device via the one or more first prompts included in the first user interface, input data representative of the first information related to the contract;
based on the first information related to the contract, unlock a button included in the first user interface, wherein the button comprises a visual icon that becomes selectable when unlocked;
based on selection of the unlocked button included in the first user interface, generate, by the contract assessment tool, data representative of a second user interface of the plurality of user interfaces for display by the agent device, wherein the second user interface includes one or more second prompts for second information related to the contract;
determine, by the contract assessment tool and based on the second information related to the contract, that negotiations for the contract are to be escalated to an enterprise legal group;
based on the determination to escalate negotiations for the contract, generate, by the contract assessment tool, a visual notification that legal escalation is required for inclusion in the first user interface and the second user interface for display by the agent device;
generate, by the contract assessment tool and based on the first and second information related to the contract, one or more reports associated with the contract; and
based on the determination to escalate negotiations for the contract, output, by the computing device, the one or more reports to one or more legal group devices within the enterprise network.
